(19) United States
(12) Patent Application Publication
(10) Pub. No.: US 2025/0027655 A1
(43) Pub. Date: Jan. 23, 2025

(54) COOKING APPLIANCE AND CONTROLLING METHOD THEREOF

(71) Applicant: LG ELECTRONICS INC., Seoul (KR)

(72) Inventors: Taehong YEO, Seoul (KR); Sungsoo KIM, Seoul (KR); Jaewon BYUN, Seoul (KR); Eunseo CHOE, Seoul (KR)

(21) Appl. No.: 18/708,698

(22) PCT Filed: Oct. 18, 2022
(86) PCT No.: PCT/KR2022/015793

§ 371 Date: May 9, 2024

(30) Foreign Application Priority Data
Jan. 7, 2022 (KR) 10-2022-0002471
May 4, 2022 (KR) 10-2022-0055322

(51) Int. Cl. F24C 15/02; E05B 47/00; H05B 6/64

(52) U.S. Cl. CPC F24C 15/022; E05B 47/0012; H05B 6/6414; E05B 2047/0017; E05B 2047/0069

(57) ABSTRACT

Disclosed is an invention relating to a cooking apparatus and a method for controlling same. The disclosed invention comprises a locking mechanism that selectively restricts the movement of a latching mechanism for fixing a door in a closed position, wherein the locking mechanism comprises a lever provided so as to allow restricting the movement of the latching mechanism, a driving unit for moving the lever, and a door configuration key for generating a signal for activating the driving unit.

### TECHNICAL FIELD

The present disclosure relates to a cooking apparatus and a method for controlling the same, and in particular, a cooking apparatus and a method for controlling the same provided with a door opening and closing a cooking compartment.

### BACKGROUND ART

Cooking apparatuses are installed in the kitchen and used to cook food items as the user wants. Cooking apparatuses can fall into different categories, based on a heat source or a type, and the sort of fuel.

Additionally, cooking apparatuses can be categorized into an open cooking apparatus in which a food item is placed in an open space, and a sealed cooking apparatus in which a food item is placed in a closed space, based on a way of cooking a food item. The sealed cooking apparatus comprises an oven, a microwave oven and the like, and the open cooking apparatus comprises a cooktop, a hob and the like.

In the sealed cooking apparatus, a space in which a food item is placed is shielded, and the shielded space is heated to cook the food item. In the sealed cooking apparatus, a chamber as a space, i.e., a cooking compartment, in which a food item is placed and which is shielded when a food item is cooked, is provided in a main body. The cooking compartment is a space in which a food item is substantially cooked. A heat source is supplied to the inner space or outer space of the cooking compartment to heat the cooking compartment.

A microwave oven in the category of sealed cooking apparatuses generates microwaves by using electricity and allows the microwaves to infiltrate into a cooking target accommodated in the cooking compartment, to heat the cooking target by triggering a molecular motion in the food item.

The microwave oven radiates a high frequency of a magnetron to a cooking target and heats the inside and outside of the cooking target at the same time. Ensuring high thermal efficiency, the microwave oven is widely used thanks to its advantages of significantly reducing cooking time of a cooking target, decreasing loss of nutrients of a cooking target during the processes of cooking, defrosting and heating the cooking target, and directly cooking a cooking target in the state of being stored in a container.

The microwave oven is provided with a door for opening and closing a cooking compartment ordinarily formed in a maim body. Based on a way of opening or closing the cooking compartment, a left-right opening-closing type door, an up-down opening-closing type door, a sliding door and the like may be applied to the door provided at the microwave oven, and in most cases, a left-right opening-closing type door may be applied to the microwave oven.

Additionally, a latch may be provided between the main body and the door to selectively fix the door opening and closing the cooking compartment. The latch detects whether the door is closed, not to proceed with cooking and the like in the state where the door is opened, while serving as a holder to keep the door closed.

Ordinarily, the latch cannot fix the door to completely prevent the door from being opened. That is, in the case where a force of predetermined magnitude or greater is applied to the door in the state where the door closes the cooking compartment, the door fixed by the latch is unfixed without additional manipulation, and accordingly, rotates or slides to open the cooking compartment.

With the above-described door opening and closing structure, as the user pulls the door, the door is easily opened. Thus, the cooking compartment may be opened unintentionally due to the user's mistake or a child's mistake and the like while the microwave oven operates.

In the case where the cooking compartment is opened unintentionally during the operation of the microwave oven, the user may be burned or injured due to heat in the cooking compartment in which a food item is being cooked.

Additionally, in the case where a child frequently opens and closes the door even when cooking is not performed, the latch may be rapidly worn, and the worn latch may result in an unreliable opening and closing operation of the door.

A door locking structure of an oven range is disclosed in prior art document 1 (KR Patent Publication No. 10-1995-0019743). As illustrated in FIG. 18 of prior art document 1, an operation rod 8 is installed at a gas range part 3 in the upper portion of a main body of a cooking apparatus, and a locking hole 13 is formed in the upper portion of a door 10.

In the state where the operation rod 8 is pressed, the operation rod 8 is inserted into the locking hole 13 and coupled to the door 10. Accordingly, the door 10 is locked with respect to the main body, such that the door 10 is not opened arbitrarily.

As the operation rod 8 is pulled upward, the operation rod 8 escapes from the locking hole 13 of the door 10. Accordingly, the door 10 may open the main body.

In the case of a door locking device of prior art document 1, the user needs to hold the operation rod 8 and pulls the operation rod upward, to open the door 10.

The operation of holding and pulling the operation rod 8 upward is more cumbersome than an operation of simply pushing or touching the operation rod.

Additionally, since a hold ring jaw 8a of the operation rod 8 is coupled to a hold part 7′ of an elastic piece 7 in the state where the operation rod 8 is coupled to the door 10, a force large enough to decouple the hold ring jaw 8a and the hold part 7′ is required to separate the operation rod 8 from the door 10.

That is, in the case of a door locking device of prior art document 1, a cumbersome and difficult operation is required to open the door 8 by using a force of pulling the operation rod 8 upward and the like.

Additionally, in the case of a door locking device of prior art document 1, the operation rod 8 needs to be pressed in the case where the door 10 is locked after the door 10 having opened the main body closes the main body again.

That is, in the case where the door 10 unlocked is locked again as well as the case where the door 10 locked by the operation rod 8 is unlocked, the user needs to hold and manipulate the operation rod 8 directly.

At this time, the user may often forget to lock the door 10 with the operation rod 8, and accordingly, the cooking compartment may be opened unintentionally, increasing the possibility of a safety-related accident.

Further, in the case of a door locking device of prior art document 1, the operation rod 8 protrudes to the outside of the oven range. The protruding object may cause deterioration in the aesthetic quality of the oven range.

A safety device for a microwave oven is disclosed in prior art document 2 (KR Patent Publication No. 10-1999-0030842). The safety device for a microwave oven disclosed in prior art document 2, as illustrated in FIG. 19, comprises a solenoid 2 and a switch 4.

As the switch 3 operates with a door 52 closed, a plunger of the solenoid 2 is inserted into a catching hole 1 formed on the lateral surface of the door 52. The door 52 is fixed by the plunger, and accordingly, the door 52 is locked with respect to a main body 2, such that the door 10 is not opened arbitrarily.

However, in prior art document 2, the door 52 is not locked automatically by the solenoid 2. That is, in the case where the door 52 is closed, the solenoid 2 does not operate automatically, and accordingly, the switch 3 needs to be manipulate to unlock the door 52 and lock the door 52 unlocked.

Further, according to prior art document 2, the catching hole 1 is formed on the lateral surface of the door 52. The catching hole 1 is formed in such a way that the catching hole penetrates the lateral surface of the door 52. The catching hole 1 may be necessarily required for inserting the plunger of the solenoid 2, but cause deterioration in the aesthetic quality of a microwave oven while protruding outward as the door 52 is opened.

### PRIOR ART DOCUMENT

### Patent Document

Document 1: KR Patent Publication No. Oct. 10, 1995-0019743

Document 2: KR Patent Publication No. 10-1999-0030842

### DESCRIPTION OF THE INVENTION

### Technical Problems

The objective of the present disclosure is to provide a cooking apparatus and a method for controlling the same that suppresses arbitrary opening of a door effectively and cancels the locking of the door conveniently and easily without a cumbersome and difficult operation.

Another objective of the present disclosure is to provide a cooking apparatus that has an improved structure to resume the locking of the door without additional manipulation.

Another objective of the present disclosure is to provide a method for controlling a cooking apparatus, in which an operation for preventing arbitrary opening of the door is properly controlled depending on an operation state of the cooking apparatus and an opening state of the door and the like.

Another objective of the present disclosure is to provide a cooking apparatus that has an improved structure, to ensure the locking of the door highly reliably, while suppressing deterioration in the aesthetic quality of the cooking apparatus, caused by a structure for door locking.

Another objective of the present disclosure is to provide a method for controlling a cooking apparatus, in which arbitrary opening of the door, caused by a manipulation error resulting from a changed mind or a mistake of the user, is suppressed.

Another objective of the present disclosure is to provide a cooking apparatus that has an improved structure in which the door is reliably fixed to prevent a cooking compartment from being opened unintentionally.

Another objective of the present disclosure is to provide a cooking apparatus that has an improved structure to allow the door to be fixed and unfixed conveniently and easily.

Yet another objective of the present disclosure is to provide a method for controlling a cooking apparatus, in which the locking of the door is resumed without additional manipulation after the locking of the door is canceled.

### Technical Solutions

In one aspect, a cooking apparatus comprises a latching mechanism coupled to a main body and configured to fix a door in a closed position, and a locking mechanism configured to selectively restrict the movement of the latching mechanism coupled to the main body.

Accordingly, the latching mechanism may be reliably fixed, and based on the fixation of the latching mechanism, the door is reliably fixed.

A method for controlling a cooking apparatus of one embodiment comprises proceeding with an opening allowance operation only in the case where the door is in the closed position at a time of manipulation of a door configuration key.

Accordingly, the locking mechanism may be prevented from operating unnecessarily, and a failure caused by a frequent operation of the locking mechanism may be suppressed.

In another aspect, in the state where the door closes a cooking compartment, the movement of the latching mechanism is allowed at a time of manipulation of the door configuration key.

In another aspect, unless the position of the door changes to an open position within a set period in the state where the locking mechanism allows the opening of the door, the locking mechanism resumes the closing of the door.

Accordingly, the cooking apparatus of this embodiment may prevent an accident caused by a manipulation error resulting from a changed mind or a mistake of the user, and prevent the arbitrary opening of the door 20 reliably.

In another aspect, the cooking apparatus comprises a locking mechanism configured to selectively restrict the movement of the latching mechanism fixing the door in the closed position, the locking mechanism comprising a lever configured to restrict the movement of the latching mechanism, a driving unit configured to move the lever, and a door configuration key configured to generate a signal for operating the driving unit.

Accordingly, an arbitrary opening of the door 20 may be suppressed conveniently and easily, only by pressing the door configuration key, without causing cumbersome and difficult manipulation.

In another aspect, the cooking apparatus comprises a latch board disposed at the front side of the main body, a latching mechanism coupled to the latch board and configured to fix the door in the closed position, and a locking mechanism configured to fix the latching mechanism in the state of being coupled to the latch board, the locking mechanism being installed at the latch board.

In another aspect, the cooking apparatus comprises the locking mechanism configured to selectively restrict the movement of the latching mechanism fixing the door in the closed position, and a sensing part configured to detect whether the door is closed, and as the door is moved to the closed position, the locking mechanism moves to a position where the locking mechanism restricts the movement of the latching mechanism.

Accordingly, the closing of the door may be resumed without additional manipulation at a time of closing the door.

In another aspect, the cooking apparatus comprises the locking mechanism configured to selectively restrict the movement of the latching mechanism fixing the door in the closed position, and manipulation switches configured to generate a different signal respectively, and as the plurality of manipulation switches is manipulated at the same time, a door locking function of the locking mechanism is canceled.

Accordingly, a double door-fixation function of fixing the door automatically and reliably, and a function of maintaining the state where the double door-fixation function is canceled may be provided together.

A cooking apparatus in one aspect may comprise a main body configured to have a coking compartment therein and an open front surface; a door disposed at a front of the main body and configured to open and close the cooking compartment; a latching mechanism installed at the door in such a way that the latching mechanism is selectively coupled to the main body, and coupled to the main body to fix the door in a closed position; and a locking mechanism configured to selectively restrict a movement of the latching mechanism.

The locking mechanism may comprise a locker configured to comprise a lever provided in such a way that the lever is movable to a restricted position where the lever restricts the movement of the latching mechanism and movable to an allowed position where the lever allows the movement of the latching mechanism; a driving unit configured to move the lever; and a door configuration key configured to generate a signal for operating the driving unit.

Preferably, the locker comprises a rotation shaft rotated around an up-down axis by the driving unit; and the lever configured to protrude from the rotation shaft in a centrifugal direction, and to move in connection with a rotation of the rotation shaft.

Preferably, the latching mechanism moves upward in the fixed position to move from the fixed position to the unfixed position, and in the restricted position, the lever restricts an upward movement of the latching mechanism, over the latching mechanism.

Preferably, the lever comprises a first lever part configured to protrude from the rotation axis in the centrifugal direction; and a second lever part configured to protrude in a direction where the lever moves from the allowed position to the restricted position, while protruding the end portion of the first lever part.

Preferably, the cooking apparatus further comprises a first sensing part configured to detect the position of the lever.

Preferably, the locker further comprises a contact projection configured to protrude from the rotation shaft in the centrifugal direction.

Preferably, the contact projection moves in connection with the rotation of the rotation shaft, the first sensing part detects a position of the lever while being turned on ON/off OFF by the contact projection.

Preferably, the cooking apparatus further comprises a latch board provided at the main body, and a latch fixation part is provided at the latch board in such a way that the latch fixation part is exposed to the front of the main body to allow the latching mechanism to be coupled to the latch board.

Preferably, at least any one of the locker and the driving unit is installed t the latch board.

Preferably, the latch board comprises a first support part disposed to the upper side of the latch fixation part and coupled with the driving unit; and a second part disposed at the lower side of the first support part and configured to rotatably support the locker.

Preferably, the cooking apparatus further comprises a firsts sensing part configured to detect the position of the lever.

Preferably, the locker further comprises a contact projection configured to protrude from the rotation shaft in the centrifugal direction, and the first sensing part is disposed in a position where the first sensing part contacts the contact projection and coupled to the first support part.

Preferably, the contact projection is disposed further upward than the lever, and the first sensing part is coupled to the first support part, over the lever, and disposed at a height where the first sensing part contacts the contact projection.

Preferably, the contact projection turns on ON the first sensing part, while contacting the first sensing part, in the case where the lever is in the restricted position.

Preferably, as the first sensing part is tuned on ON, the operation of the driving unit stops to maintain the position of the lever in the restricted position.

Preferably, the cooking apparatus further comprises a second sensing part configured to detect whether the door is in the closed position.

Preferably, the latch board further comprises a third support part coupled with the second sensing part.

Preferably, the driving unit operates to change the position of the lever from the allowed position to the restricted position in the case where the door moves to the closed position and the second sensing part is turned on ON.

Preferably, the cooking apparatus further comprises a first manipulation switch configured to generate a signal different from a signal of the door configuration key.

Preferably, in the case where the first manipulation switch and the door configuration key generate a signal at the same time, the operation of the driving unit stops to maintain the lever in the allowed position.

Preferably, the cooking apparatus further comprises a second manipulation switch configured to generated a signal different from a signal of the door configuration key and a signal of the first manipulation switch.

Preferably, in the case where at least any one of the first manipulation switch and the second manipulation switch and the door configuration key generate a signal at the same time, the operation of the driving unit stops to maintain the lever in the allowed position.

Further, in one aspect, a cooking apparatus comprises a main body configured to have a coking compartment therein and an open front surface; a door disposed at a front of the main body and configured to open and close the cooking compartment; a latching mechanism installed at the door in such a way that the latching mechanism is selectively coupled to the main body, and coupled to the main body to fix the door in a closed position; and a locking mechanism configured to fix the latching mechanism in the state of being coupled to the main body, the locking mechanism selectively restricting the movement of the latching mechanism coupled to the main body.

Further, in one aspect, a cooking apparatus comprises a main body configured to have a coking compartment therein and an open front surface; a door disposed at a front of the main body and configured to open and close the cooking compartment; a latch board disposed at a front side of the main body; a latching mechanism installed at the door in such a way that the latching mechanism is selectively coupled to the latch board, and coupled to the latch board to fix the door in a closed position; and a locking mechanism configured to fix the latching mechanism in the state of being coupled to the latch board, the locking mechanism being disposed at the latch board.

In another aspect, a method for controlling a cooking apparatus comprising a latching mechanism configured to fix a door, which opens and closes a cooking compartment while moving to a closed position and an open position, in the closed position, and a locker provided in such a way that the locker is movable to a restricted position where the locker restricts a movement of the latching mechanism or movable to an allowed position where the locked allows a movement of the latching, and an opening allowance operation proceeds only when the door is in the closed position, at a time of manipulation of a door configuration key.

The opening allowance operation may be an operation of moving the locker to the allowed position.

The cooking apparatus may further comprise an input key for inputting an operation set value.

Preferably, at a time of manipulation of the door configuration key, a set value delete operation proceeds in the state where the operation set value is input by the input key.

The set value delete operation may be an operation of deleting the operation set value input by the input key.

Preferably, in the case where the door is in the open position, and the door configuration key is manipulated in the state where the operation configuration value is input by the input key, the set value delete operation only proceeds out of the opening allowance operation and the set value delete operation.

Preferably, in the case where the door is in the closed position, and the door configuration key is manipulated in the state where the operation configuration value is input by the input key, the opening allowance operation and the set value delete operation proceed together.

The cooking apparatus may further comprise a heating unit configured to generate heat of a high frequency into the cooking compartment.

Preferably, at a time of operation of the heating unit, the opening allowance operation does not proceed eve if the door configuration key is manipulated in the state where the door is in the closed position.

Preferably, as the door configuration key is manipulated while the heating unit operates, the operation of the heating unit stops.

Preferably, as the door configuration key is manipulated at a time of operation of the heating unit, the opening allowance operation proceeds.

Further, unless a position of the door changes to the open position within a set period after the opening allowance operation proceeds, a door control operation may proceed.

The door control operation may be an operation of moving the locker to the restricted position.

The cooking apparatus may further comprise a first sensing part configured to detect a position of the locker.

Further, as the locker moves to the allowed position and contacts the first sensing part at a time when the opening allowance operation proceeds, the first sensing part may be turned on ON.

Preferably, as the first sensing part is turned on ON, the movement of the locker stops.

The cooking apparatus may further comprise a second sensing part configured to detect whether the door is in the closed position.

Further, in the case where the door moves from the allowed position to the closed position and the second sensing part is turned on ON, a door control operation may proceed.

The door control operation may be an operation of moving the locker to the restricted position.

### Advantageous Effects

In the above-described method for controlling the cooking apparatus of the present disclosure, the opening allowance operation may proceed only in the state where the door closes the cooking compartment at a time of manipulation of the door configuration key, such that the locking mechanism is prevented from operating unnecessarily.

Thus, according to the present disclosure, a failure of the locking mechanism, caused due to a frequent operation of the locking mechanism, may be effectively prevented, and arbitrary opening of the door may be prevented reliably.

According to the present disclosure, an additional input key for controlling a door locking function may not be required in addition to an input key provided at an ordinary cooking apparatus, such that the door locking function is effectively controlled only with an existing input key.

Accordingly, an increase in the number of components may be suppressed to a maximum degree, and the cooking apparatus may provide a highly reliable door locking function.

According to the present disclosure, since the additional input key for controlling the door locking function may not be required, the cooking apparatus may be highly compatible with an existing cooking apparatus, and the possibility of a change in the design of the exterior of an existing cooking apparatus, caused by an addition of the input key, may be suppressed.

According to the present disclosure, the door may be reliably fixed by the locking mechanism provided to fix the latching mechanism to the main body such that the door keeps the cooking compartment closed, to effectively prevent the cooking compartment from being opened unintentionally during the operation of the cooking apparatus.

According to the present disclosure, the locking of the door may be conveniently and easily canceled simply by manipulating the manipulation switch without causing cumbersome and difficult manipulation, to provide a highly reliable and convenient cooking apparatus.

According to the present disclosure, the locking of the door may be ensured highly reliably without deterioration in the aesthetic quality of the cooking apparatus, caused due to the locking mechanism, and the reliability of the cooking apparatus may be ensured.

According to the present disclosure, a double door-fixation function of fixing the door automatically and reliably, and a function of maintaining the state where the double door-fixation function is canceled in the case where the double door-fixation function is not required may be provided together, to enable the cooking apparatus to selectively provide the double door-fixation function when necessary.

According to the present disclosure, a two-stage locking function comprised of two or more operations for opening of the door may be provided, and when necessary, may be easily canceled conveniently and easily, to improve the reliability and convenience of the cooking apparatus.

According to the present disclosure, the locking mechanism may automatically fix the door closing the cooking compartment without additional manipulation, based on the locking mechanism's operation of fixing the door, to improve the reliability of the cooking apparatus and ensure ease of manipulation.

According to the present disclosure, the door may be fixed and unfixed conveniently and easily, to suppress frequent opening and closing of the door unnecessarily, effectively suppressing unreliable opening and closing operation of the door, caused by an abnormally rapidly worn latching mechanism.

### BRIEF DESCRIPTION OF THE DRAWINGS

FIG. 1 is a perspective view showing a cooking apparatus of one embodiment.

FIG. 2 is a perspective view showing the cooking apparatus in FIG. 1 with a door open.

FIG. 3 is a perspective view showing a state in which a locking mechanism of one embodiment is installed.

FIG. 4 is a lateral cross-sectional view showing the inner structure of a cooking apparatus illustrated in FIG. 3.

FIG. 5 is a block diagram schematically showing an example of the configuration of the cooking apparatus of one embodiment.

FIG. 6 is a planar cross-sectional view showing the inner structure of a cooking apparatus illustrated in FIG. 3.

FIG. 7 is a planar cross-sectional view showing the inner structure of a cooking apparatus comprising a first sensing part.

FIG. 8 is a perspective view separately showing a portion of the locking mechanism of one embodiment.

FIG. 9 is an exploded perspective view showing a state in which the locking mechanism illustrated in FIG. 8 is exploded.

FIG. 10 is a perspective view separately showing a locker illustrated in FIG. 8.

FIG. 11 is a planar cross-sectional view showing a lock cancelation state of a locking mechanism illustrated in FIG. 7.

FIG. 12 is a lateral cross-sectional view showing a lock cancelation state of a locking mechanism illustrated in FIG. 4.

FIG. 13 is a view schematically showing switches illustrated in FIG. 5.

FIG. 14 is a flowchart showing a process in which the operation of the locking mechanism of one embodiment is controlled.

FIG. 15 is a block diagram schematically showing the configuration of a cooking apparatus of another embodiment.

FIG. 16 is a view schematically showing switches illustrated in FIG. 15.

FIG. 17 is a flowchart showing a process in which the operation of the locking mechanism of one embodiment is controlled.

FIG. 18 is a side view showing a partially cut oven range of a related art with its door closed.

FIG. 19 is a cross-sectional view showing a state in which a safety device for an electric range of a related art is applied.

### DETAILED DESCRIPTION OF EXEMPLARY EMBODIMENTS

The above-described aspects, features and advantages are specifically described hereafter with reference to accompanying drawings such that one having ordinary skill in the art to which the disclosure pertains can embody the technical spirit of the disclosure easily. In the disclosure, detailed description of known technologies in relation to the subject matter of the disclosure is omitted if it is deemed to make the gist of the disclosure unnecessarily vague. Hereinafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components are not to be restricted by the terms. Certainly, a first component can be a second component, unless stated to the contrary.

Embodiments are not restricted to the embodiments set forth herein, and can be modified and changed in various different forms. The embodiments in the disclosure are provided such that the disclosure can be through and complete and fully convey its scope to one having ordinary skill in the art. Accordingly, all modifications, equivalents or replacements as well as a replacement of the configuration of any one embodiment with the configuration of another embodiment or an addition of the configuration of any one embodiment to the configuration of another embodiment, within the technical spirit and scope of the disclosure, are to be included in the scope of the disclosure.

The accompanying drawings are provided for a better understanding of the embodiments set forth herein and are not intended to restrict the technical spirit of the disclosure. It is to be understood that all the modifications, equivalents or replacements within the spirit and technical scope of the disclosure are included in the scope of the disclosure. The sizes or thicknesses of the components in the drawings are exaggerated or reduced to ensure ease of understanding and the like. However, the protection scope of the subject matter of the disclosure is not to be interpreted in a restricted way.

The terms in the disclosure are used only to describe specific embodiments or examples and not intended to restrict the subject matter of the disclosure. In the disclosure, singular forms include plural forms as well, unless explicitly indicated otherwise. In the disclosure, the terms “comprise”, “comprised of” and the like specify the presence of stated features, integers, steps, operations, elements, components or combinations thereof but do not imply the exclusion of the presence or addition of one or more other features, integers, steps, operations, elements, components or combinations thereof.

The terms “first”, “second” and the like are used herein only to distinguish one component from another component, and the components are not to be restricted by the terms.

When any one component is described as “connected” or “coupled” to another component, any one component can be directly connected or coupled to another component, but an additional component can be “interposed” between the two components or the two components can be “connected” or “coupled” by an additional component. When any one component is described as “directly connected” or “directly coupled” to another component, an additional component cannot be “interposed” between the two components or the two components cannot be “connected” or “coupled” by an additional component.

When any one component is described as being “on (or under)” another component, any one component can be directly on (or under) another component, and an additional component can be interposed between the two components.

Unless otherwise defined, all the terms including technical or scientific terms used herein have the same meaning as commonly understood by one having ordinary skill in the art. Additionally, terms such as those defined in commonly used dictionaries are to be interpreted as having a meaning that is consistent with their meaning in the context of the relevant art, and unless explicitly defined herein, are not to be interpreted in an ideal way or an overly formal way.

In the state where a cooking apparatus stands on the floor, a direction in which a door is installed with respect to the center of the cooking apparatus is defined as a forward direction. Accordingly, a direction toward the inside of the cooking apparatus with the door open is defined as a rearward direction. For convenience, the forward direction and the rearward direction can be referred to as a first direction. Then the forward direction is referred to as one direction of the first direction, and the rearward direction is referred to as the other direction of the first direction.

Additionally, a gravitational direction can be defined as a downward direction, and a direction opposite to the gravitational direction can be defined as an upward direction.

Further, a horizontal direction across a front-rear direction of the cooking apparatus, i.e., a widthwise direction of the cooking apparatus that is seen in front of the door of the cooking apparatus, can be referred to as a left-right direction. For convenience, the left-right direction can be referred to as a second direction. Then the right side can be referred to as one direction of the second direction, and the left side can be referred to as the other direction of the second direction.

Further, the widthwise direction of the cooking apparatus can also be referred to as a lateral direction. Then the right side can also be referred to as one side of the lateral direction, and the left side can be referred to the other side of the lateral direction.

Additionally, an up-down direction can be referred to as a third direction. Then the upward direction can be referred to as one direction of the third direction, and the downward direction can be referred to as the other direction of the third direction.

Furthermore, the up-down direction can be referred to as a vertical direction. Then the front-rear direction and the left-right direction, i.e., the first direction and the second direction, can be referred to as the horizontal direction.

Throughout the disclosure, the terms “A and/or B” as used herein can denote A, B or A and B, and the terms “C to D” can denote C or greater and D or less, unless stated to the contrary.

### [Entire Structure of Cooking Apparatus]

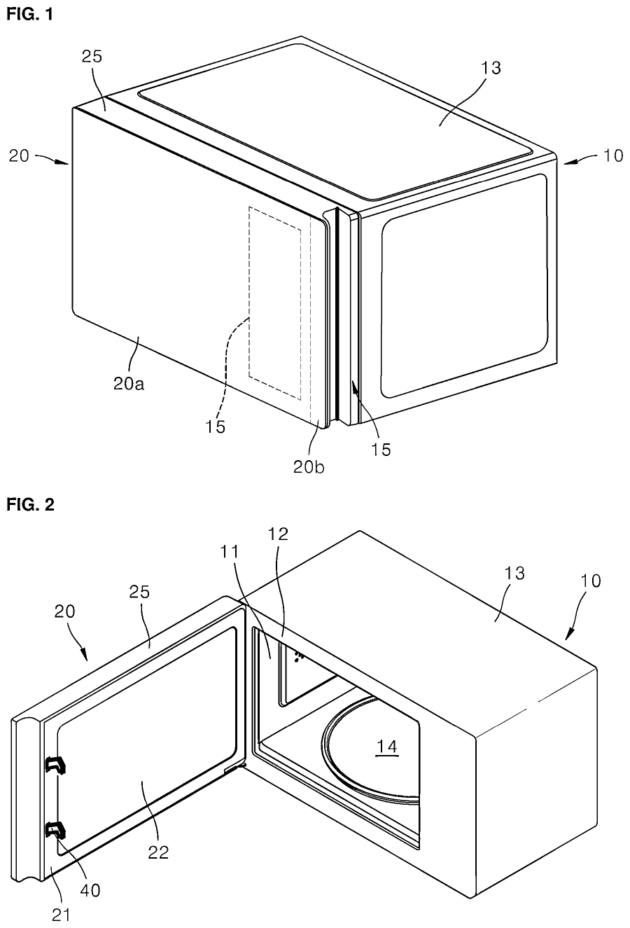

FIG. 1 is a perspective view showing a cooking apparatus of one embodiment, and FIG. 2 is a perspective view showing the cooking apparatus in FIG. 1 with a door open.

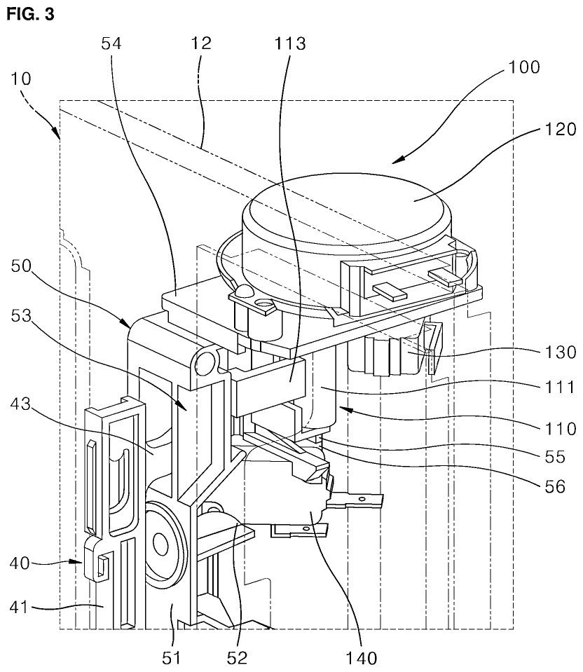

Referring to FIGS. 1 and 3, the exterior of the cooking apparatus of one embodiment is formed by a main body 10. The main body 10 may have a shape comprising an approximate rectangular cuboid shape, and be made of a material having predetermined strength to protect a plurality of parts that are installed in the inner space of the main body. The main body 10 may comprise a cavity 11 and a cabinet 13.

The cavity 11 may form the inner skeleton of the main body 10. The cavity 11 may be shaped into a cuboid the front surface of which is open. A cooking compartment 14 may be formed in the cavity 11. The cooking compartment 14 may have a shape corresponding to the inner shape of the cavity 11, i.e., be shaped into a cuboid the front surface of which is open.

The cooking compartment 14 may be shaped into a cuboid the front surface of which is open. The inner space of the cooking compartment 14 is heated, with the cooking compartment 14 closed, to perform cooking. That is, in the cooking apparatus, the inner space of the cooking compartment 14 is a space in which a food item is cooked substantially.

The cabinet 13 may form the exterior of the main body 10, outside the cavity 11. The cabinet 13 may form the exterior of the main body 10 while covering the cavity 11 from the upper portion and the lateral portion of the cavity 11.

In this embodiment, a front plate 12 is disposed at the front of the cavity 11, for example.

The front plate 12 may form the exterior of the front surface of the main body 10, at the front of the cavity 11. In an example, the front plate 12 may be provided in the form of a metal sheet having a hollow hole.

A door 20 selectively opening and closing the cooking compartment 14 may be swivably provided at the front of the main body 10. The door 20 may open and close the cooking compartment 14, based on a side-swing method in which the other side of the door 20 in the lateral direction thereof swivels left and right around one side of the door in the lateral direction thereof. For example, the door 20 may close the cooking compartment 14 in a closed position, and open the cooking compartment 14 by swiveling in the closed position.

The door 20 may be shaped into a cuboid that has a predetermined thickness entirely. Additionally, a hinge may be installed between the main body 10 and the door. The hinge may be disposed at one side of the main body 10 in the lateral direction thereof and may rotatably couple one side of the door 20 in the lateral direction thereof to the main body 10. The door 20 may be rotatably coupled to the hinge, on the front surface of the main body 10, and open and close the cooking compartment 14 while rotating around the hinge.

Additionally, a heating unit for heating in the cooking compartment 14 is provided in the main body 10. The heating unit may generate heat or high frequencies into the cooking compartment 14. The heating unit may be embodied as one sort of heating unit, or two or more sorts of heating units.

In this embodiment, the heating unit comprises a magnetron that may supply a high-frequency heat source into the cooking compartment 14, for example. The magnetron may be placed and installed in the upper portion or lateral portion of the cooking compartment 14, while being installed in the main body 10.

Further, an electric component compartment may be formed in the main body 10 and disposed in the upper portion or lateral portion of the cooking compartment 14 in the main body 10. In this embodiment, the magnetron and the electric component compartment are disposed in the lateral portion of the cooking compartment 14, for example. Electric components such as a magnetron, a high-voltage transformer and the like may be installed in the electric component compartment.

### [Structure of Door]

The door 20 may comprise a door panel 21 forming the skeleton of the door 20. The door panel 21 may have a cuboid shape corresponding to the shape of the front surface of the main body 10. In this embodiment, the door panel 21 is made of a metallic material having predetermined strength, for example.

Additionally, a door frame 25 may be installed outside the door panel 21. The door frame 25 may form the exteriors of the front surface, upper surface, lower surface and lateral surface of the door 20, and be shaped into a cuboid the rear surface of which is open. The door panel 21 may be accommodated in the door frame 25.

Further, a hinge may be installed at one side of the door frame 25 in the lateral direction thereof, and swivably couple the door panel 21 to the main body 10. The hinge may be installed respectively at the upper end and the lower end at one side of the door frame 25 in the lateral direction thereof.

The door 20 formed by the door panel 21 and the door frame 25 as described above may comprise a door main body part 20a covering the front of the cooking compartment 14, and a handle part 20b for the user to grip using a hand.

Further, a control panel 15 may be provided at the door 20. The control panel 15 may be disposed between the door main body part 20a and the handle part 20b. The control panel 15 may be shaped into a cuboid having a predetermined inner space.

In this embodiment, most of the area of the door 20 corresponds to the door main body part 20a and the control panel 15. That is, at the door 20, most of the area of the door 20 corresponds to the door main body part 20a and the control panel 15 except for the handle 20b described hereinafter.

The door main body part 20a and the control panel 15 may be arranged in the lateral direction. For example, the control panel 15 may be disposed at the other side of the door main body part 20a in the lateral direction thereof. A partition wall may partition between the door main body part 20a and the control panel 15 arranged as described above.

An input part to which the user inputs a manipulation signal for operating the cooking apparatus may be provided on the front surface of the control panel 15. Additionally, a display unit may be further provided at the control panel 15 and provide information on the operations of the door and the cooking apparatus provided with the door or information on cooking of a food item and the like, and the user, and the user may see a variety of information on the cooking apparatus through the display unit.

In this embodiment, the door main body part 20a may open and close the cooking compartment 14 by rotating around one side of the door main body part 20a in the lateral direction thereof, and the control panel 15 may be disposed at the other side of the door main body part 20a in the lateral direction thereof. Additionally, the handle part 20b may be formed to protrude from the control panel 15 toward the other side of the control panel 15 in the lateral direction thereof. That is, the control panel 15 may be disposed between the door main body part 20a and the handle part 20b.

In an example, the door frame 25 may form the skeletons of the door main body part 20a and the control panel 15, and a portion extending from the door frame 25 toward the other side of the door frame 25 in the lateral direction thereof may be the handle part 20b.

Specifically, the front surfaces of the door main body part 20a and the control panel 15 and the front surface of the handle part 20b may form the same planar surface, on the front surface of the door 20. Additionally, the lateral surface of the handle part 20b may be depressed toward one side of the handle part 20b in the lateral direction thereof. That is, the handle part 20b may be formed in such a way that the handle part 20b is depressed in the lateral direction.

The inner space of the handle part 20b may be open toward the other side of the handle part 20b in the lateral direction thereof, and the user may open and close the door 20 in the state where the user puts a hand into the inner space of the handle part and holds the handle part 20b.

Further, the cooking apparatus may further comprise a latching mechanism 40. The latching mechanism 40 may be provided to fix the door 20 in the closed position.

In this embodiment, the latching mechanism 40 is installed at the door 20, for example. As the door 20 closes the cooking compartment 14, the latching mechanism 40 installed at the door 20 as described above may penetrate a latch slot formed in such a way that the latch slot penetrates the front surface of the main body 10 and be inserted into the main body 10.

The latching mechanism 40 inserted into the main body 10 as described above may be engaged with and coupled to a latch board 50 installed in the main body 10 to fix the door 20 to the main body 10 selectively.

Based on the operation of the latching mechanism 40, the swivel of the door 20 with respect to the main body 10 may be limited such that the cooking compartment 14 remains shielded by the door 20 substantially.

Additionally, based on an operation of detecting whether the latching mechanism 40 and the latch board 50 are engaged with each other, it may be detected whether the door 20 is closed, and accordingly, the operation of the cooking apparatus may be controlled such that the cooking apparatus is prevented from proceeding with cooking in the state where the door 20 is open.

In this embodiment, the latch board 50 is installed on the front plate 12 disposed at the front of the cavity 11, and the latching mechanism 40 installed at the door 20 is coupled to the latch board 50, for example.

Further, the cooking apparatus may further comprise a locking mechanism 100. The locking mechanism 100 may fix the latching mechanism 40 to latch board 50 by restricting the movement of the latching mechanism 40. The locking mechanism 100 may be provided to fix the latching mechanism 40 in the state where the latching mechanism 40 fixing the door 20 in the closed position is coupled to the latch board 50.

That is, the locking mechanism 100 may prevent the latching mechanism 40 and the latch board 50 from being decoupled by restricting the movement of the latching mechanism 40 coupled to the latch board 50.

Thus, in the cooking apparatus of this embodiment, the door 20 may be provided in the state of being fixed by the latching mechanism 40, and the latching mechanism 40 may be provided in the state of being fixed by the locking mechanism 100. That is, in the case of a cooking apparatus of this embodiment, for the door 20 to open the cooking compartment 14, the latching mechanism 40 and the main body 10 need to be decoupled, and the latching mechanism 40 fixed by the locking mechanism 100 also needs to be unfixed.

### [Structures of Latching Mechanism and Latch Board]

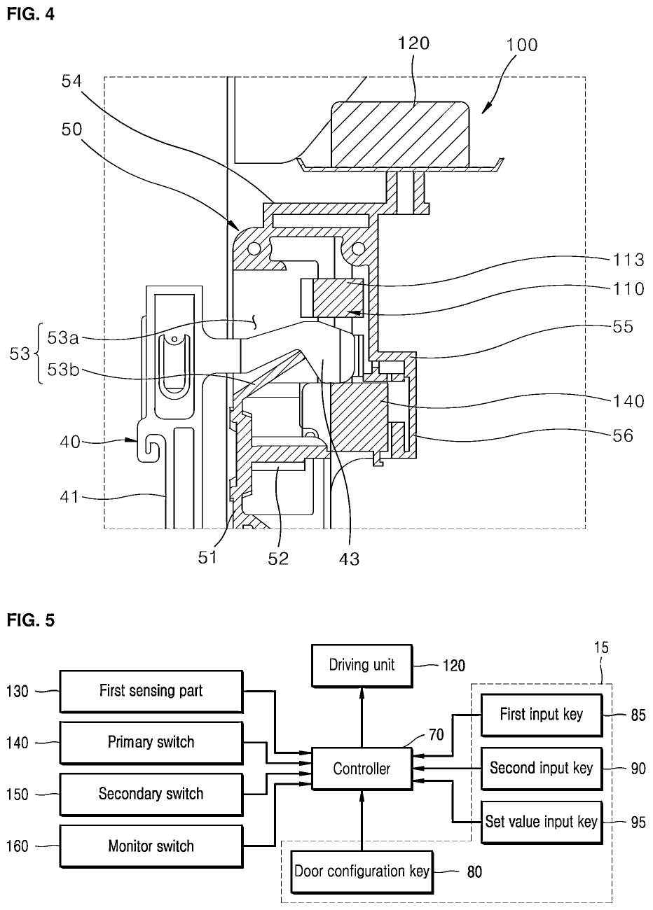

FIG. 3 is a perspective view showing a state in which a locking mechanism of one embodiment is installed, and FIG. 4 is a lateral cross-sectional view showing the inner structure of a cooking apparatus illustrated in FIG. 3.

Referring to FIGS. 2 to 4, the latch board 50 may be installed at the front side of the main body 10, specifically, on the front plate 12. The latch board 50 may comprise a latch board main body part 51 and a latch fixation part 53.

The latch board main body part 51 may form the skeleton of the latch board 50 and be installed on the front plate 12. The length of the latch board main body part 51 in the front-rear direction thereof and the length of the latch board main body part 51 in the left-right direction may be less than the length of the latch board main body part 51 in the up-down direction, for example, be shaped into a rod that stands in the vertical direction.

The latch board main body part 51 may be disposed at the rear of the front plate 12 and coupled to the front plate 12. For example, in the state where the front surface of the latch board main body part 51 touches the rear surface of the front plate 12, the latch board main body part 51 and the front plate 12 may be coupled to each other.

For a coupling between the latch board main body part 51 and the front plate 12, a fastening boss 52 may be provided at the latch board 50. The fastening boss 52 may be formed to protrude rearward from the front surface of the latch board main body part 51.

A fastening hole may be formed at the front plate 12 and the fastening boss 52 in such a way that the fastening hole penetrates the front plate 12 and the fastening boss 52 in the front-rear direction, and a fastening member such as a screw and the like may be coupled to the front plate 12 and the fastening boss 52 while penetrating the front plate 12 and the fastening boss 52 through the fastening hole.

The latch fixation part 53 may be provided to be coupled to the latching mechanism 40. The latch fixation part 53 may be provided to be exposed to the front of the main body 10, and comprise a insertion hole 53a and a hold step 53b.

A latch slot may be formed at the front plate 12 in such a way that the latch slot penetrates the front plate 12 in the front-rear direction. The latch slot may form a passage required for the latching mechanism 40 to penetrate the front plate 12 in the front-rear direction. The latch fixation part 53 may be exposed to the front of the main body 10 through the latch slot.

The insertion hole 53a may be provided to connect to a penetration hold formed at the front plate 12. The insertion hole 53a may be formed inside the latch board main body part 51 in such a way that the insertion hole 53a penetrates the latch board main body part 51 in the front-rear direction. The latching mechanism 40 may be inserted into the latch fixation part 53 through the insertion hole 53a.

The latching mechanism 40 provided to be coupled to the latch board 50 selectively may be installed at the door 20 in such a way that the latching mechanism 40 is movable to a fixed position and an unfixed position. In the case where the latching mechanism 40 is in the fixed position, the latching mechanism 40 may be coupled to the main body 10, specifically, the latch board 50, to fix the door 20 in the closed position. Additionally, in the case where the latching mechanism 40 is in the unfixed position, the door 20 may separate from the main body 10 to open the cooking compartment 14.

The latching mechanism 40 may be movable to the fixed position by moving toward the main body 10 rearward, and movable to the unfixed position by moving far away from the main body 10 forward. The latching mechanism 40 may comprise a latch lever 41 and a latch 43.

The latch lever 41 may be installed in the door 20 in such a way that the latch lever 41 is movable in the up-down direction. In an example, the latch lever 41 may be shaped into a rod extending in the up-down direction.

The latch lever 41 may be elastically supported by an elastic member provided in the door 20. The elastic member supporting the latch lever 41 may provide an elastic force of moving the latch lever 4, having moved upward, downward

The latch 43 may protrude rearward from the latch lever 41. In an example, the latch 43 may be shaped into a hook the rear end portion of which protrudes downward. The latch 43 may pass through the front plate 12 through the latch slot, and be inserted into the latch board 50 through the insertion hole 53a. The latch 43 inserted into the latch board 50 as described above may be coupled to the latch board 50 in such a way that the latch 43 is held by the rear surface of the latch board 50.

In the case where the latching mechanism 40 is in the fixed position, i.e., the case where the latching mechanism 40 is coupled to the latch board 50, the rear end portion of the latch 43 inserted into the latch board 50 may be disposed further downward than the insertion hole 53a. In this state, the latch 43 may be coupled to the latch board 50 in such a way that the latch 43 is held by the rear surface of the latch board 50.

That is, in the case where the posture of the locker 110 is in a locked posture, the latch 43 and the latch board 50 may be coupled to each other, while the rear surface of the latch 43 and the rear surface of the latch board 50 touch each other in the front-rear direction, such that a forward movement of the latch 43 is restricted by the latch board 50.

In this embodiment, a pair of latches 43 arranged in the up-down direction is provided at the latching mechanism 40, and in response, a pair of latch fixation parts 53 is arranged at the latch board 50 in the up-down direction, for example.

However, the subject matter of the present disclosure is limited to the above description, and three or more latches 43 may be provided at the latching mechanism 40, and in response, three or more latch fixation parts 53 may be provided at the latch fixation part 53. The latching mechanism 40 and the latch board 50 may be modified in various different forms.

In this embodiment, a hold step 51b may be provided at the latch board 50. The hold step 51b may be disposed under the insertion hole 53a. The hold step 51b may be formed to extend from the front surface of the latch board 50 rearward, and define a lower boundary of the insertion hole 53a.

In the case where the latching mechanism 40 is in the fixed position, the rear end portion of the latch 43 inserted into the latch board 50 may be disposed further downward than the insertion hole 53a. In this state, the latch 43 may be coupled to the latch board 50 in such a way that the latch 43 is held by the rear end portion of the hold step 51b.

The hold step 51b may form an inclination surface inclining upward from the front side of the latch board 50 toward the rear side thereof. As the latching mechanism 40 is inserted into the latch board 50, the latch 43 may be movable to the insertion hole 53a along the inclination surface of the hold step 51b. That is, the hold step 51b may effectively lead the locker 110 to move for a coupling between the locker 110 and the latch board 50.

In the case where the latching mechanism 40 is coupled to the latch board 50, the lower surface of the latch 43 contacting the hold step 51b may form an inclination surface inclining forward and upward.

As the latching mechanism 40 moves from the fixed position to the unfixed position, the latch 43 may move forward while the lower surface of the latch 43 moves up along the rear end portion of the hold step 51b. As the latch 43 is moved forward as described above, the latching mechanism 40 may be decoupled from the latch board 50 while the latch 43 escapes from the latching mechanism 40.

At this time, the direction in which the latching mechanism 40 moves is a direction between the forward direction and the upward direction. That is, for the latching mechanism 40 to move from the fixed position to the unfixed position, the latching mechanism 40 needs to move in the upward direction as well as in the forward direction.

Additionally, the latch board 50 may further comprise a first support part 54 and a second support part 55. The first support part 54 and the second support part 55 may be provided on the latch board 50, to support the locking mechanism 100. Detailed structures of the first support part 54 and the second support part 55 are described hereinafter.

### [Structure of Locking Mechanism]

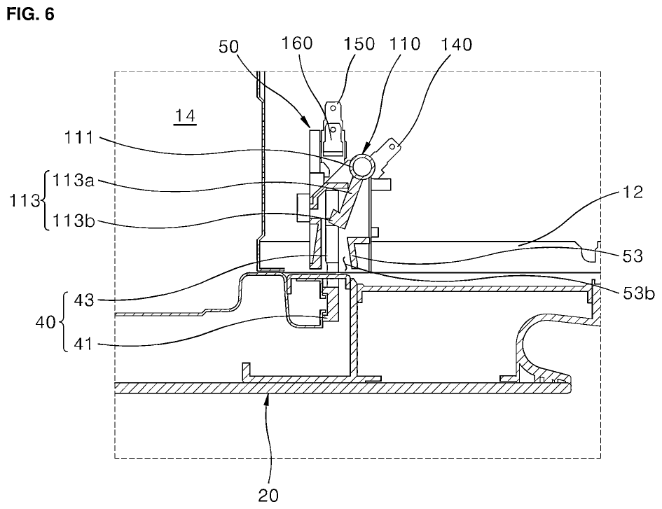

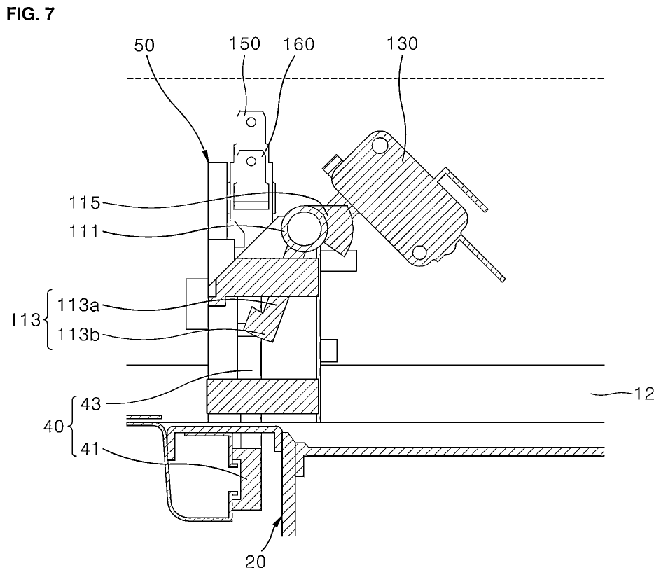

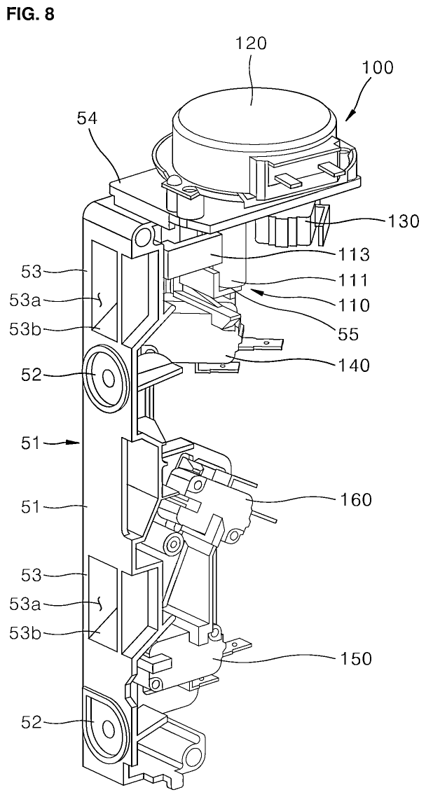

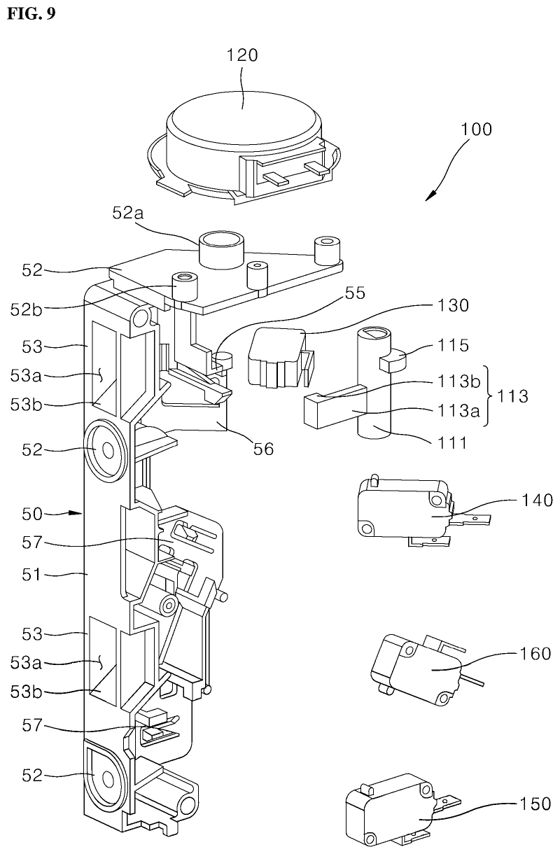

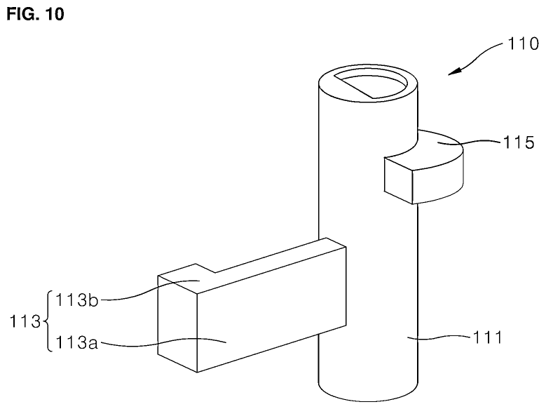

FIG. 5 is a block diagram schematically showing an example of the configuration of the locking mechanism of one embodiment, and FIG. 6 is a planar cross-sectional view showing the inner structure of a cooking apparatus illustrated in FIG. 3. Additionally, FIG. 7 is a planar cross-sectional view showing the inner structure of a cooking apparatus comprising a first sensing part, and FIG. 8 is a perspective view separately showing a portion of the locking mechanism of one embodiment. Further, FIG. 9 is an exploded perspective view showing a state in which the locking mechanism illustrated in FIG. 8 is exploded, and FIG. 10 is a perspective view separately showing a locker illustrated in FIG. 8.

Referring to FIGS. 4 to 7, the locking mechanism 100 may comprise a locker 110 and a driving unit 120. At least any one of the locker 110 and the driving unit 120 included in the locking mechanism 100 may be installed at the latch board 50. In this embodiment, both the locker 110 and the driving unit 120 are installed at the latch board 50, for example.

The locker 110 is provided to selectively restrict the movement of the latching mechanism 40. The locker 110 may be installed at the latch board 50 and comprise a rotation shaft 111 and a lever 113.

The rotation shaft 111 may be provided in such a way that the rotation shaft 111 is rotatable around an up-down axis. The rotation shaft 111 may connect to the driving unit 120 described hereinafter and be rotated by the driving unit 120.

In this embodiment, the first support part 54 and the second support part 55 are arranged in the up-down direction, for example. The rotation shaft 111 may be disposed between the first support part 54 and the second support part 55. In an example, the upper end of the rotation shaft 111 may be rotatably coupled to the first support part 54, and the lower end of the rotation shaft 111 may be rotatably disposed at the second support part 55.

The lever 113 may connect to the rotation shaft 111 such that the lever 113 moves in connection with the rotation of the rotation shaft 111. The lever 113 may be shaped into a projection protruding from the rotation shaft 111 in the centrifugal direction.

The lever 113 may be provided in such a way that the lever 113 is movable to a restricted position and an allowed position. In the case where the lever 113 is in the restricted position, the lever 113 may restrict the movement of the latching mechanism 40. Additionally, in the case where the lever 113 is in the allowed position, the lever 113 may allow the movement of the latching mechanism 40.

As described above, for the latching mechanism 40 to move from the fixed position to the unfixed position, the latching mechanism 40 needs to move in the upward direction as well as in the forward direction. That is, unless the latching mechanism 40 moves upward, the latching mechanism 40 may not move from the fixed position to the unfixed position.

In the case where the lever 113 is in the restricted position, the lever 113 may restrict an upward movement of the latching mechanism 40 over the latching mechanism 40 to keep the latching mechanism 40 in the fixed position.

Specifically, the lever 113 may be disposed over the latch 43. In this embodiment, the lever 113 is disposed over a latch 43 that is disposed upward out of a pair of latches 43 provided at the latching mechanism 4, for example.

In the case where the lever 113 is in the restricted position, the lever 113 may be disposed on a path in which the latch 43 moves in the up-down direction. The lever 113 may restrict an upward movement of the latch 43 while interfering with the latch 43 over the latch 43. Accordingly, the lever 113 may fix the position of the latch 43 such that the latch 43 does not get out of a coupling with the latch fixation part 53.

To this end, at least a portion of the lever 113 may be inserted into the latch fixation part 53. In the case where the lever 113 is in the restricted position, at least a portion of the lever 113 is inserted into the latch fixation part 53, specifically, the insertion hoe 53a.

At least a portion of the lever 113, inserted into the insertion hole 53a as described above, may be disposed on a path in which the latch 43 moves upward, over the latch 43. Accordingly, the lever 113 may restrict the movement of the latch 43 such that the latch 43 is not movable upward in the insertion hole 53a.

The lever 113, as illustrated in FIGS. 7 to 10, may comprise a first lever part 113a and a second lever part 113b.

The first lever part 113a may be formed to protrude from the rotation shaft 111. The first lever part 113a may protrude from the rotation shaft 111 in the centrifugal direction.

In an example, the rotation shaft 111 may be disposed in a position that is spaced a predetermined distance apart from the latch 43 coupled to the latch fixation part 53 in the lateral direction. Additionally, the first lever part 113a may protrude at a length that is enough to cover the upper portion of the latch 43 coupled to the latch fixation part 53, while protruding from the rotation shaft 111.

In the case where the lever 113 is in the restricted position, the first lever part 113a may restrict an upward movement of the latch 43 while interfering with the latch 43, over the latch 43.

The second lever part 113b may be formed to protrude from the end portion of the first lever part 113a. The second lever part 113b may protrude in a direction where the rotation shaft 111 rotates. Specifically, the second lever part 113b may protrude in a direction where the lever 113 moves from the allowed position to the restricted position. For example, under the assumption that the lever 113 moves clockwise as the lever 113 moves from the allowed position to the restricted position, the second lever part 113b may protrude from the end portion of the first lever part 113a clockwise.

The second lever part 113a formed as described above may help to expand an area where the lever 113 covers the latch 43 from above, such that the lever 113 ensures the fixation of the latch 43 efficiently and reliably.

The locking mechanism 100 may further comprise a first sensing part 130. The first sensing part 130 is provided to detect the position of the lever 113.

In this embodiment, the first sensing part 130 is provided in such a way that the first sensing part 130 comprises a microswitch, for example. The first sensing part 130 may be turned on ON/off OFF based on the movement of an actuator protruding on the microswitch.

For example, in the case where the actuator of the microswitch remains unmoved, the first sensing part 130 may remain turned off. OFF. It may be found that the lever 113 is in the restricted position, through the first sensing part 130 remaining turned off OFF.

As the actuator of the microswitch moves, the first sensing part 130 may be turned on ON. It may be found that the lever 113 is in the allowed position, through the first sensing part 130 turned on ON.

The locker 110 may further comprise a contact projection 115. The contact projection 115 may be formed to protrude from the rotation shaft 111. The contact projection 115 may protrude from the rotation shaft 111 in the centrifugal direction.

In an example, the locker 110 may be disposed between the latching mechanism 40 and the first sensing part 130. For example, the latching mechanism 40 may be disposed at the front side of the locker 110, and the first sensing part 130 may be disposed at the rear side of the locker 110.

The lever 113 may protrude approximately forward, i.e., toward the latch 43 from the rotation shaft 111. Additionally, the contact projection 115 may protrude rearward, i.e., toward the first sensing part 130.

The contact projection 115, like the lever 113, may move in connection with the rotation of the rotation shaft 111. In an example, in the case where the lever 113 is in the allowed position, the contact projection 115 may contact the actuator protruding on the microswitch. Additionally, as the lever 113 is moved to the restricted position, the contact projection 115 may move to a position spaced from the microswitch.

As the actuator protruding on the microswitch moves based on contact with the contact projection 115, the first sensing part 130 may be turned on. Accordingly, the first sensing part 130 may sense that the lever 113 is in the allowed position.

Further, as the contact projection 115 moves to a position spaced from the microswitch, the first sensing part 130 may be turned off OFF. It may be found that the lever 113 is in the restricted position through the first sensing part 130 turned off OFF as described above.

As described above, the latch board 50 of this embodiment may comprise a first support part 54 and a second support part 55, and the first sensing part 130 may be coupled to the first support part 54.

The first support part 54 may be disposed at the upper side of the latch fixation part 53. In an example, the first support part 54 may be disposed further upward than a latch fixation part 53 that is disposed upward out of a pair of latch fixation parts 53 arranged in the up-down direction.

The driving unit 120 may be coupled to the first support part 54. In an example, the first support part 54 may be provided in the form of a horizontal planar surface that protrudes rearward from the upper end of the latch board main body part 51. The driving unit 120 may be coupled to the first support part 54 in such a way that the driving unit 120 sits on the upper surface of the first support part 54 shaped into a planar surface as described above.

The first support part 54 may be provided with a first support boss 54a and a second support boss 54b. The first support boss 54a and the second support boss 54b may be formed to protrude upward from the first support part 54. The driving unit 120 may sit on the upper ends of the first support boss 54a and the second support boss 54b, such that the driving unit 120 is spaced a predetermined distance apart from the first support part 54 upward.

The first support boss 54a may be disposed to the center in a direction of the planar surface of the driving unit 120. Additionally, the driving unit 120 may comprise a motor having a driving shaft extending downward. The driving shaft of the motor may be disposed to the center in the direction of the planar surface of the driving unit 120, and connect to the rotation shaft 111 of the locker 110 by penetrating the first support boss 54a in the up-down direction.

In this embodiment, a plurality of second support bosses 54b is spaced a predetermined distance apart from each other in the front-rear direction or the lateral direction, for example. The second support boss 54b disposed as described above may support the driving unit 120 reliably, together with the first support boss 54a.

The locker 110 may be disposed at the lower side of the first support part 54. The driving unit 120, specifically, the driving shaft of the motor, may connect to the rotation shaft 111 of the locker 110 by penetrating the first support part 54 in the up-down direction. The locker 110 having the rotation shaft 111 connected to the driving shaft as described above may be rotated by the driving unit 120, under the first support part 54.

The first sensing part 130 may be disposed at the rear of the locker 110, and coupled to the first support part 54. The first sensing part 130 may be disposed in a position where the first sensing part is contactable with the contact projection 115 and coupled to the first support part 54. Specifically, the first sensing part 130 may be disposed in a position where the actuator of the microswitch is contactable with the contact projection 115, and in this position, the first sensing part 130 may be coupled to the first support part 54.

The first sensing part 130 may be coupled to the first support part 54, at the lower side of the first support part 54. That is, the first sensing part 130 may be disposed in a space between the first support part 54 and the second support part 55, and coupled to the lower surface of the first support part 54.

The contact projection 115 may be disposed at a height where the contact projection 115 is contactable with the first sensing part 130 installed as described above. In an example, the contact projection 115 may be disposed further upward than the lever 113.

Both the lever 113 and the first sensing part 130 are installed at the latch board 50, and the first sensing part 130 is installed at the first support part 54 that is disposed at an uppermost end of the latch board 50. That is, the first sensing part 130 may be disposed in a position of a height the same as the lever 113 or higher than the lever 113.

Considering that the latch 43 and the lever 113 are inserted into the latch fixation part 53 disposed under the first support part 54, the first sensing part 130 installed at the first support part 54 may be disposed in a position higher than the latch 43 and the lever 113.

To be disposed at a height where the contact projection 115 is contactable with the first sensing part 130 disposed in the above-described position, the contact projection 115 may be disposed at least at a height that is the height of the lever 113 or greater.

In this embodiment, the contact projection 115 is disposed at a height greater than that of the lever 113, for example. In the case where the contact projection 115 is at the same height as the lever 113 or at a height less than that of the lever 113, the contact projection 115 may interfere with the movement of the latch 43.

For example, as the lever 113 is moved to an unlocked position, the lever 113 may escape from a path in which the latch 43 moves, but at least a portion of the contact projection 115 may be disposed on the path in which the latch 43 moves. At this time, if the contact projection 115 is disposed in a position higher than that of the insertion hole 53a, the contact projection 115 does not interfere with an upward movement of the latch 43. However, if the contact projection 115 is disposed in a position where the contact projection 115 is inserted into the insertion hole 53a, the contact projection 115 is likely to interfere with an upward movement of the latch 43.

Considering this, the contact projection 115 is disposed in a position higher than that of the lever 113 in this embodiment. Accordingly, the first sensing part 130 and the contact projection 115 at the upper end side of the latch board 50 may smoothly contact each other, and the contact projection 115 may interfere with the movement of the latch 43 such that a failure in the opening of the door 20 is suppressed effectively.

The second support part 55 may be disposed downward than the first support part 54. In this embodiment, the second support part 55 is disposed at the rear side of the latch fixation part 53, for example. The second support part 55 is provided to support the locker 110 rotatably.

In an example, the second support part 55 may be provided to protrude rearward from the latch board main body part 51. The second support part 55 may comprise a support frame 55a and a support shaft 55b.

The support frame 55a may be formed to protrude rearward from the front surface of the latch board main body part 51. Additionally, the support shaft 55b may be formed to protrude upward from the support frame 55a.

The lower end of the rotation shaft 111 may be rotatably coupled to the support shaft 55b. Accordingly, the second support part 55 may support the locker 110 rotatably, under the locker 110.

### [Structure Regarding Control of Locking Mechanism]

The cooking apparatus of this embodiment may further comprise a second sensing part 140, 150, 160. The second sensing part 140, 150, 160 is provided to detect whether the door 20 is in the closed position.

In this embodiment, like the first sensing part 130, the second sensing part 140, 150, 160 is provided in such a way that the second sensing part 140, 150, 160 comprises a microswitch, for example. The second sensing part 140, 150, 160 may be turned on ON/off OFF based on the movement of an actuator protruding on the microswitch and detect the position of the door 20.

For example, in the case where the actuator of the microswitch is moved by the latch 43, the second sensing part 140, 15, 160 may be turned on ON, and accordingly, sense that the door 20 is in the closed position.

Additionally, in this embodiment, the second sensing part 140, 150, 160 comprises a primary switch 140, a secondary switch 150 and a monitor switch 160, for example.

In an example, the primary switch 140 may be turned on ON in the case where the door 20 closes the cooking compartment 14, to allow a power source to be supplied to a high-voltage part such as a high-voltage transformer and a magnetron and the like.

Further, the primary switch 140 may remain turned off OFF in the case where the door 20 opens the cooking compartment 14, to stop a power source from being supplied to the high-voltage part such as a high-voltage transformer and a magnetron and the like.

Further, together with the primary switch 140, the secondary switch 140 may detect the position of the door 20. Based on a result of the secondary switch 140's detecting the position of the door 20, a power supply to the cooking apparatus may be controlled.

In this embodiment, a power supply to the locking mechanism 100 is controlled based on a result of the secondary switch 140's detecting the position of the door 20, for example.

Further, the monitor switch 150 may remain turned off OFF in the case where the door 20 closes the cooking compartment 14, and then, in the case where the door 20 opens the cooking compartment 14, may be turned on ON to constitute an electrical closed-loop circuit, and may bypass an input voltage.

The monitor switch 150 may cut off a power supply to the cooking apparatus in the case of an operation error of the primary switch 130 and the secondary switch 140, such that the monitor switch together with the first sensing part 130 and the secondary switch 140 performs a safety function.

Further, the latch board 50 may further comprise a third support part 56. The third support part 56 may be disposed further downward than the second support part 55. In this embodiment, the third support part 56 is disposed at the rear side of the latch fixation part 53, for example. The third support part 56 may be formed to protrude rearward from the front surface of the latch board main body part 51.

Any one of the second sensing parts 140, 150, 160, specifically, the primary switch 140, may be coupled to the third support part 56. The primary switch 140 may be coupled to the third support part 56, fixed to the rear side of the latch fixation part 53, and installed in a position where the primary switch 140 directly and indirectly contacts the latch 43 coupled to the latch fixation part 53.

A hook 56a may be provided at the lower side of the second support part 55, or between the second support part 55 and the third support part 56. The hook 56a, together with the third support part 56, may be used to fix the primary switch 140 to the latch board 50, fix the latch board 50 to the main body 10, or fix the latch board 50 to a component or a structure disposed in the main body 10.

Further, the latch board 50 may further comprise at least one of fourth support parts 57. The fourth support part 57 may be disposed further downward than the third support part 56, and have a shape similar to that of the third support part 56 while protruding from the front surface of the latch board main body part 51.

A plurality of fourth support parts 57 may be arranged in the up-down direction. Additionally, a portion of the second sensing parts 140, 150, 160, i.e., at least any one of the secondary switch 150 and the monitor switch 160, may be coupled to the fourth support part 57 and fixed onto the latch board 50.

In an example, a pair of fourth support parts 57 may be disposed at the latch board 50, and the secondary switch 150 and the monitor switch 160 may be respectively coupled to the pair of fourth support parts 57. Accordingly, the secondary switch 150 and the monitor switch 160 may be arranged in the up-down direction.

The cooking apparatus of this embodiment may further comprise a controller 70. The controller 70 may control the entire operation of the cooking apparatus, and control the operation of the locking mechanism 100.

The controller 70 may connect to the first sensing part 130 and the second sensing part 140, 150, 160. The controller 70 may control the operation of the locking mechanism 100 based on a result of the detection of the first sensing part 130 and the second sensing part 140, 150, 160. That is, the controller 70 may control the operation of the driving unit 120, based on signal transmitted from the first sensing part 130 and the second sensing part 140, 150, 160.

In an example, as the second sensing part 140, 150, 160 is turned on ON and transmits a signal to the controller 70, the controller 70 may determine that the door 20 is in the closed position. In the case where the door 20 is in the closed position, the controller 70 may control the operation of the driving unit 120 such that the locker 110 moves to the restricted position.

Additionally, as the first sensing part 130 is turned on ON and transmits a signal to the controller 70, the controller 70 may determine that the locker 110 is moved to the allowed position. In the case where the locker 110 is in the allowed position, the controller 70 may control the operation of the driving unit 120 such that the locker 110 does not move any more.

Further, the cooking apparatus of this embodiment may further comprise a door configuration key 80. The door configuration key 80 may connect to the controller 70, and generate a signal for the operation the driving unit 120. The controller 70 may control the operation of the driving unit 120 based on a signal transmitted by the door configuration key 80.

In this embodiment, the door configuration key 80 is disposed at the control panel 15 (see FIG. 1), for example. Specifically, the door configuration key 80 may be provided at the input part of the control panel 15. The door configuration key 80 may be provided in such a way that the door configuration key 80 is pressed by the user.

In an example, in the case where the door configuration key 80 is pressed to transmit a signal to the controller 70, the controller 70 may control the operation of the driving unit 120 such that the locker 110 moves to the allowed position. That is, the door configuration key 80 may be provided as a switch for canceling the state in which the door 20 is locked by the locking mechanism 100.

### [Operation and Effect of Locking Mechanism]

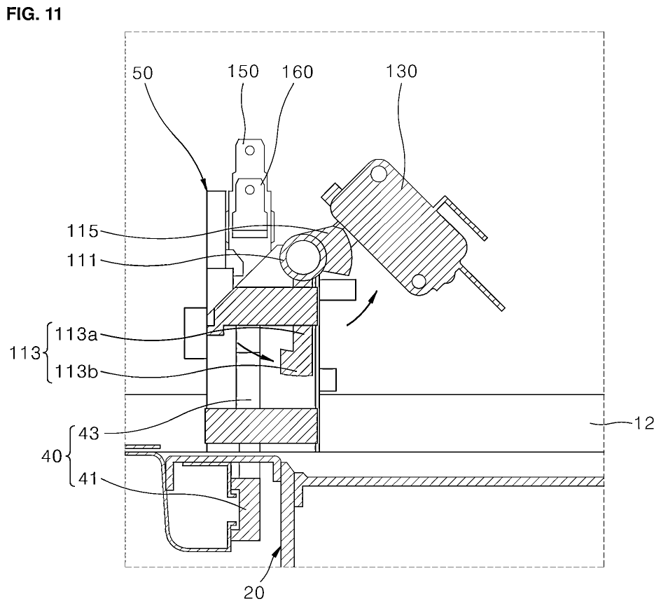

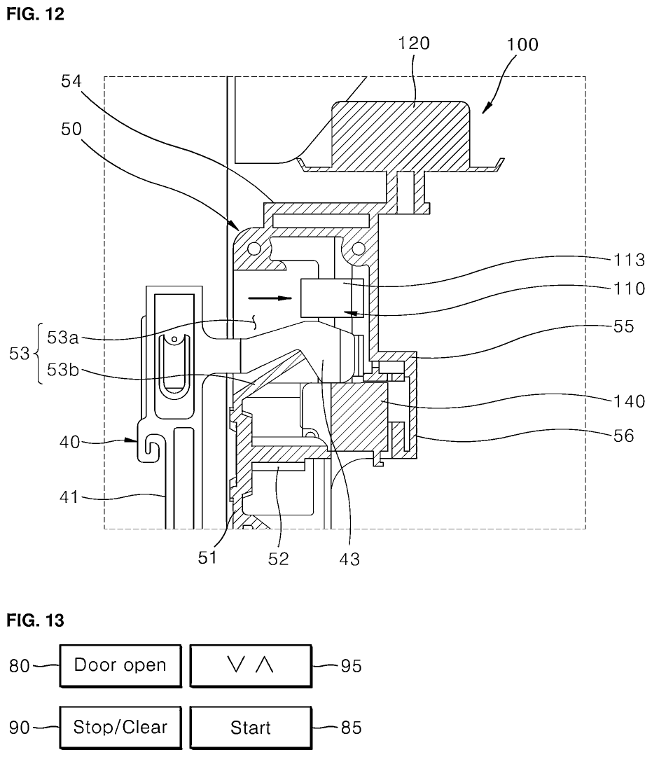

FIG. 11 is a planar cross-sectional view showing a lock cancelation state of a locking mechanism illustrated in FIG. 7, and FIG. 12 is a lateral cross-sectional view showing a lock cancelation state of a locking mechanism illustrated in FIG. 4.

Hereinafter, the operation and effect of the cooking apparatus of this embodiment are described with reference to FIGS. 4 to 12.

Referring to FIGS. 4 to 7, in the case where the door 20 closes the cooking compartment 14, and accordingly, the latch 43 is coupled to the latch fixation part 53, the second sensing part 140, 150, 160 may be turned on ON.

As the second sensing part 140, 150, 160, turned on ON as described above, transmits a signal to the controller 70, the controller 70 may determine that the door 20 is in the closed position. In the case where the door 20 is in the closed position, the controller 70 may control the operation of the driving unit 120 such that the driving unit 120 rotates the locker 110. Accordingly, the driving unit 120 may rotate the rotation shaft 111 of the locker 110 in one direction, e.g., in a clockwise direction, and the lever 113 may move to the restricted position.

In the case where the lever 113 is in the restricted position, the lever 113 may be disposed on the path in which the latch 43 moves in the up-down direction. The lever 113 may restrict an upward movement of the latch 43 while interfering with the latch 43, over the latch 43. Accordingly, the lever 113 may fix the position of the latch 43 such that the latch 43 does not get out of a coupling with the latch fixation part 53.

In the state where the position of the latch 43 is fixed by the locking mechanism 100 as described above, the door 20 may not be opened, although the user holds and pulls the door 20 to open the door 20. Thai is, in the cooking apparatus of this embodiment, the door 20 having closed the cooking compartment 14 may remain closed doubly by the latching mechanism 40 and the locking mechanism 100.

In the state where the door 20 is locked doubly by the latching mechanism 40 and the locking mechanism 100 as described above, the door 20 may not open the cooking compartment 14. For the door 20 to open the cooking compartment 14 in the above state, the locking of the latching mechanism 40 with the locking mechanism 100 needs to be canceled first.

That is, for the door 20 to open the cooking compartment 14, as illustrated in FIGS. 11 and 12, the movement of the latch 43, restricted by the locking mechanism 100, needs to be canceled first.

To this end, the user may operate the locking mechanism 100 by pressing the door configuration key 80. As the door configuration key 80 pressed transmits a signal to the controller 70, the controller 70 may control the operation of the driving unit 120 such that the driving unit 120 rotates the locker 110.

Accordingly, the driving unit 120 may rotate the rotation shaft 111 of the locker 110 in the other direction, e.g., in a counterclockwise direction, and the lever 113 may move to the allowed position from the restricted position.

In the case where the lever 113 is in the allowed position, the lever 113 may be disposed in a position outside the path in which the latch 43 moves in the up-down direction. Thus, the latch 43 may go into a state where the latch 43 freely moves upward without being affected by the lever 113.

In the above state, as the user holds and pulls the door 20 forward, the latch 43 may escape from the latch fixation part 53, and the latching mechanism 40 and the latch board 50 may be decoupled from each other, and the door 20 may open the cooking compartment 14 while rotating forward.

Further, as the lever 113 is moved to the allowed position as described above, the contact projection 115 may move in connection with the movement of the lever 113. The contact projection 115 moved as described above may turn on ON the first sensing part 130 while contacting the actuator of the first sensing part 130.

As the first sensing part 130 is turned on ON and transmits a signal to the controller 70, the controller 70 may determine that the locker 110 is moved to the allowed position. Accordingly, the controller 70 may stop the operation of the driving unit 120 such that the locker 110 does not move any more.

As the user pushes the door 20 such that the door 20 closes the cooking compartment 14 as illustrated in FIGS. 4 to 7, in the state where the door 20 opens the cooking compartment 14 as described above, the second sensing part 140, 150, 160 may sense this.

For example, as the door 20 closes the cooking compartment 14, i.e., the door 20 is moved to the closed position, the latch 43 coupled to the latch board 50 may turn on ON the second sensing part 140, 150, 160 while contacting the actuator of the second sensing part 140, 150, 160.

As the second sensing part 140, 150, 160 is turned on ON and transmits a signal to the controller 70, the controller 70 may determine that the door 20 is moved to the closed position. Accordingly, the controller 70 may control the operation of the driving unit 120, such that the driving unit rotates the locker 110.

Accordingly, the driving unit 120 may rotate the rotation shaft 111 of the locker 110 in one direction, e.g., in a clockwise direction, such that the lever 113 is moved to the restricted position.

In the case where the lever 113 is in the restricted position, the lever 113 may be disposed on the path in which the latch 43 moves in the up-down direction. The lever 113 may restrict an upward movement of the latch 43 while interfering with the latch 43, over the latch 43. Accordingly, the lever 113 may fix the position of the latch 43 such that the latch 43 does not get out of a coupling with the latch fixation part 53.

Further, as the lever 113 is moved to the restricted position as described above, the contact projection 115 may also move in connection with the movement of the lever 113. Accordingly, the contact projection 115 is released from its contact with the actuator of the first sensing part 130, and the first sensing part 130 may be turned off OFF.

In the case where the ON state of the first sensing part 130 changes to the OFF state, the controller 70 may determine that the locker 110 is moved to the restricted position from the allowed position. Accordingly, the controller 70 may stop the operation of the driving unit 120, such that the locker 120 remains in the restricted position.

As the door 20 having opened the cooking compartment 14 as described above is moved to the closed position again and closes the cooking compartment 14, the locking of the latch 43 may be resumed by the locking mechanism 100 without additional manipulation to the locking mechanism 100.

That is, in the case of a cooking apparatus of this embodiment, the latch 43 locked by the locking mechanism 100 may be unlocked only by pressing the door configuration key 80, and without additional manipulation, the latch 43 may be locked again by the locking mechanism 100.

Accordingly, in the case of a cooking apparatus of this embodiment, the door 20 may be fixed and unfixed conveniently and readily to prevent the cooking compartment 14 from being opened unintentionally, and without additional manipulation, the door 20 may be automatically fixed.

Additionally, the locking mechanism 100 of this embodiment may allow the door 20 to be fixed and unfixed conveniently and easily, and frequent unnecessary opening and closing of the door 20 may be suppressed.

The cooking apparatus of this embodiment may be provided with the locking mechanism 100, and effectively suppress unreliability in the opening and closing operation of the door 20, caused by the latching mechanism 40 that is worn abnormally rapidly.

Further, the locking mechanism 100 may be installed in the main body 10. That is, the locker 110, the driving unit 120 and the like included in the locking mechanism 100 may all be accommodated in the main body 10 and not exposed to the outside of the cooking apparatus.

That is, the locking mechanism 100 may be installed in the main body 10 not to be exposed to the outside of the cooking apparatus, and in the main body 10, restrict the movement of the latch 43 inserted into the main body 10.

The locking mechanism 100 may not be exposed to the outside of the cooking apparatus regardless of the position of the door 20 and the position of the lever 113 of the locker 110.

Thus, the locking mechanism 100 may help the door 20 to be locked reliably without causing deterioration in the aesthetic quality of the cooking apparatus.

### [Function Cancelation Operation of Locking Mechanism]

FIG. 13 is a view schematically showing switches illustrated in FIG. 5.

Referring to FIGS. 11 to 13, the cooking apparatus of this embodiment may further comprise a first input key 85 and a second input key 90. The first input key 85 and the second input key 90 may respectively connect to the controller 70, and generate a signal for the operation of the cooking apparatus. The controller 70 may control the operation of the cooking apparatus, based on the signal transmitted from the first input key 85 and the second input key 90.

In an example, the first input key 85 may generate a signal for initiating the cooking of the cooking apparatus, and the second input key 90 may generate a signal for stopping the operation of the cooking apparatus performing cooking.

In this embodiment, the first input key 85 and the second input key 90 together with the door configuration key 80 are provided at the input part of the control panel 15, for example. The first input key 85 and the second input key 90 may be provided in such a way that the first input key 85 and the second input key 90 are pressed by the user.

The user may press the first input key 85 to allow the cooking apparatus to initiate cooking, and press the second input key 90 to allow the cooking apparatus to stop cooking. Additionally, the user may press the door configuration key 80 to cancel the locking function of the door 20 with the locking mechanism 100.

Further, a set value input key 95 may be further provided at the input part of the control panel 15. The set value input key 95 may be provided to input an operation set value.

In an example, the operation set value may be a set value in relation to the operation of the heating unit. For example, the operation set value may be a set value in relation to time or intensity and the like for which the heating unit heats a cooking target. That is, the heating intensity or heating time and the like of the heating unit may be set, based on the manipulation of the set value input key 95.

In this embodiment, in the case where at least two or more of the door configuration key 80, the first input key 85 and the second input key 90 are pressed, the function of the locking mechanism 100 may be canceled. As the function of the locking mechanism 100 is canceled, the latch 43 may not be locked by the locking mechanism 100, even in the state where the door 20 closes the cooking compartment 14.

For example, as the function of the locking mechanism 100 is canceled, the lever 113 may remain in the allowed position. Further, in this state, although the second sensing part 140, 150, 160 senses that the door 20 has closed the cooking compartment 14, the lever 113 does not move to the restricted position.

That is, as the function of the locking mechanism 100 is canceled, the lever 113 may remain in the allowed position, and the locking mechanism 100 may remain in a state where the locking mechanism 100 allows the latch 43 to move freely.

The locking mechanism 100 of this embodiment may provide the double door-fixation function of fixing the door 20 automatically and reliably, and in the case where the double door-fixation function is not needed, remain in a state where the double door-fixation function is canceled.

In the case of a cooking apparatus of this embodiment, the double door-fixation function may be canceled for households without children, which do not need the double door-fixation function, such that the double door-fixation function is selected when necessary.

In an example, in the case where all the door configuration key 80, the first input key 85 and the second input key 90 are pressed, the function of the locking mechanism 100 may be canceled. In another example, in the case where any one of the first input key 85 and the second input key 90, and the door configuration key 80 are pressed at the same time, the function of the locking mechanism 100 may be canceled. In yet another example, in the case where the first input key 85 and the second input key 90 are pressed at the same time, the function of the locking mechanism 100 may be canceled.

In this embodiment, the odor configuration key 80, the first input key 85 and the second input key 90 are provided at the cooking apparatus, for example, but not limited.

In another example, any one of the first input key 85 and the second input key 90, and the door configuration key 80 may be provided at the cooking apparatus. At this time, in the case where two switches are pressed at the same time, the function of the locking mechanism 100 may be canceled.

In yet another example, other switches in addition to the door configuration key 80, the first input key 85 and the second input key 90 may be further provided at the cooking apparatus, and in the case where four or more switches are pressed at the same time, the function of the locking mechanism 100 may be canceled.

### [Example of Control of Operation of Locking Mechanism]

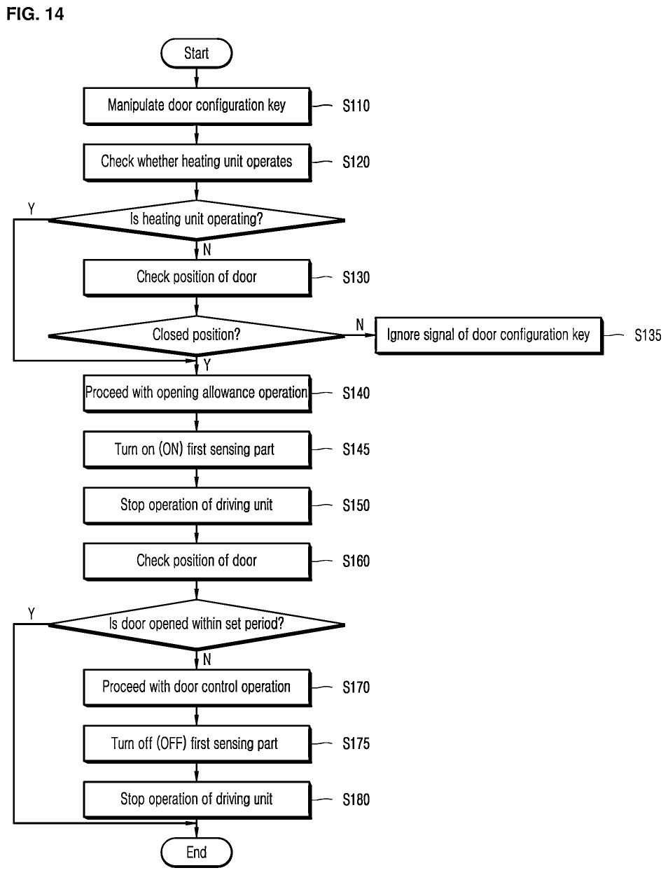

FIG. 14 is a flowchart showing a process in which the operation of the locking mechanism of one embodiment is controlled.

Hereinafter, the process of controlling the operation of the locking mechanism of one embodiment is described with reference to FIGS. 11 to 14.

Referring to FIGS. 11 to 14, for the user to open the door 20, the door configuration key 80 needs to be manipulated first. As the user presses the door configuration key 80 (S110), the controller 70 may check the position of the door 20 first (S130).

The second sensing part 140, 150, 160 may check the position of the door 20. In the case where the door 20 is coupled to the latch fixation part 53 while closing the cooking compartment 14 (see FIG. 2), the second sensing part 140, 150, 160 may be turned on ON. As the second sensing part 140, 150, 160 turned on ON as described above transmits a signal to the controller 70, the controller 70 may determine that the door 20 is in the closed position.

Additionally, in the case where the door 20 escapes from the latch fixation part 53 while opening the cooking compartment 14, the second sensing part 140, 150, 160 may be turned off OFF. As the second sensing part 140, 150, 160 is turned off OFF as described above, the controller 70 may determine that the door 20 is in the open position.

In an example, the controller 70 may check the state of the door 20 depending on results of the sensing of the secondary switch 150, and based on the information, may control the operation of the locking mechanism 100.

For example, the controller 70 may control the supply of power to the high-voltage part such as a high-voltage transformer and a magnetron and the like, depending on results of the sensing of the primary switch 140, and control the operation of the locking mechanism 100 based on results of the sensing of the secondary switch 150.

In the case where the secondary switch 150 is turned off OFF, the controller 70 may be aware that the door 20 is in the open position. At this time, the controller 70 ignores a signal input to the controller 70 based on the manipulation of the door configuration key 80, such that any operation in relation to the manipulation of the door configuration key 80 does not proceed (S135).

In the case where the secondary switch 150 is turned on ON, the controller 70 may be aware that the door 20 is in the closed position. At this time, the controller 70 may proceed with an opening allowance operation (S140).

In this embodiment, the opening allowance operation is defined as an operation of moving the locker 110 to the allowed position. To proceed with the opening allowance operation, the controller 20 may control the operation of the driving unit 120. That is, the controller 70 may control the operation of the driving unit 120 such that the driving unit 120 rotates the locker 110 toward the allowed position.

In this embodiment, the controller 70 may proceed with the opening allowance operation only in the case where the door 20 is in the closed position, in other words, in the case where the door 20 closes the cooking compartment 14.

That is, the controller 70 does not proceed with the opening allowance operation despite the manipulation of the door configuration key 80, in the case where the door 20 has already been in the open position. In the state where the door 20 has already opened the cooking compartment 14, the operation for opening the door 20 does not need to proceed.

Accordingly, the cooking apparatus of this embodiment may effectively suppress an increase in the possibility of failure of the locking mechanism 100, caused when the locking mechanism 100 operates unnecessarily.

Additionally, the controller 70 may see whether the heating unit operates before checking the position of the door 20 (S120).

In the case where the door configuration key 80 is manipulated at a time of operation of the heating unit, the controller 70 may proceed with the opening allowance operation (S140). Additionally, in the case where the door configuration key 80 is manipulated in the state where the heating unit does not operate, the controller 70 check the position of the door 20 (S130), and then determine whether to proceed with the opening allowance operation.

In this embodiment, the heating unit may operate only in the state where the cooking compartment 14 is closed by the door 20, in other words, only in the case where the door 20 is in the closed position. That is, in the case where the heating unit operates, it may be found that the door 20 is in the closed position.

Considering this, the controller 70 may indirectly check the position of the door 20, based on whether the heating unit operates, and then at a time of operation of the heating unit, may exclude checking the position of the door 20, and immediately proceed with the opening allowance operation.

Accordingly, the position of the door 20 does not need to be repeatedly checked unnecessarily, to effectively suppress a delay in the operation or an operational error caused due to unnecessary repetition during sensing.

In the case where the door 20 is in the closed position, and accordingly, the opening allowance operation proceeds, the driving unit 120 may rotate the rotation shaft 111 of the locker 110 in the other direction, e.g., a counterclockwise direction. Based on the rotation of the rotation shaft 111, the lever 113 may move to the allowed position from the restricted position.

In the case where the lever 113 is in the allowed position, the lever 113 may be disposed in a position that escapes from the path in which the latch 43 moves in the up-down direction. Thus, the latch 43 goes into a state where the latch 43 freely moves upward without being affected by the lever 113.

In the above state, as the user holds the door 20 and pulls the door forward, the latching mechanism 40 and the latch board 50 may be decoupled from each other while the latch 43 escapes from the latch fixation part 53, and the door 20 may open the cooking compartment 14 while rotating forward.

As the lever 113 is moved to the allowed position as described above, the contact projection 115 may move in connection with the movement of the lever 113. The contact projection 115 moved as described above may turn on ON the first sensing part 130 while contacting the actuator of the first sensing part 130 (S145).

As the first sensing part 130 is turned on ON and transmits a signal to the controller 70, the controller 70 may determine that the locker 110 moves to the allowed position. Accordingly, the controller 70 may stop the operation of the driving unit 120, to prevent the locker 110 from making an additional movement unnecessarily (S150).

After the opening allowance operation proceeds, the position of the door 20 may be checked again (S160). At this time, the second sensing part 140, 150, 160 may check the position of the door 20.

The controller 70 may check whether the position of the door 20 changes from the closed position to the open position after the opening allowance operation proceeds.

In the case where a change in the position of the door 20 to the open position is checked, the control of the locking mechanism 100's operation for opening the door 20 may end. That is, in the state where the operation of the driving unit 120 is stopped after the locker 110 is moved to the allowed position, the operation of the locking mechanism 100 may end.

The state where the operation of the locking mechanism 100 ends may be maintained until the door 20 closes the cooking compartment 14 again. As the door 20 closes the cooking compartment 14 again, the locking mechanism 100 may operate to restrict the movement of the door 20 again, as described above. The operation is the same as a door control operation described hereinafter, and the door control operation is specifically described hereinafter. Unless the position of the door 20 changes to the open position within a set period after the opening allowance operation proceeds, the controller 70 may proceed with the door control operation (S170).

In this embodiment, the door control operation is defined as an operation of moving the locker 110 to the restricted position. Accordingly, to proceed with the door control operation, the controller 70 may control the operation of the driving unit 120. That is, the controller 70 may control the operation of the driving unit 120 such that the driving unit 120 rotates the locker 110 toward the restricted position (see FIG. 4).

The set period may be set to a period that is ordinarily required to open the door 20 in the state were the locking mechanism 100 allows the opening of the door 20. For example, the set period may be set to about 10 seconds. At this time, unless the position of the door 20 changes to the open position within 10 seconds after the opening allowance operation proceeds, the controller 70 may proceed with the door control operation.

In the case where the position of the door 20 does not change to the open position within the set period in the state where the locking mechanism 100 allows the opening of the door 20, the user has no intention to open the door 20, reasonably, regardless of whether the door configuration key 80 is manipulated.

At this time, if the locking mechanism 100 keeps allowing the opening of the door 20, the locking mechanism 100 may not provide its function and may remain dysfunctional based on one-time manipulation of the door configuration key 80.

Considering this, in this embodiment, unless the door 20 is opened within a period ordinarily required for the opening of the door 20, the locking mechanism 100's operation of resuming the locking of the door 20 proceeds.

Accordingly, the cooking apparatus of this embodiment may be less affected by an adverse effect caused by a manipulation error resulting from a changed mind or a mistake of the user, and prevent the arbitrary opening of the door 20 reliably.

As the lever 110 is moved to the restricted position as described above, the contact projection 115 may move in connection with the movement of the lever 113. The contact projection 115 moved as described above may separate from the actuator of the first sensing part 130, and accordingly, the first sensing part 130 may go into the OFF state (S175).

As the first sensing part 130 is turned off OFF, the controller 70 may determine that the locker 110 is moved to the restricted position. Accordingly, the controller 70 may stop the operation of the driving unit 120, such that the locker 110 does not make an additional movement unnecessarily (S180).

That is, as the locking mechanism 100 restricts the movement of the door 20 again in the state where the door 20 closes the cooking compartment 14, the control over the operation of the locking mechanism 100 may end. That is, in the state where the operation of the driving unit 120 is stopped after the locker 110 is moved to the restricted position, the operation of the locking mechanism 100 may end.

In the above-described method for controlling the cooking apparatus of this embodiment, the opening allowance operation may proceed only in the state where the door 20 closes the cooking compartment 14 at a time of manipulation of the door configuration key 80, such that the locking mechanism 100 is prevented from operating unnecessarily.

Accordingly, the cooking apparatus of this embodiment may effectively prevent a failure of the locking mechanism 100, caused due to a frequent operation of the locking mechanism 100, and prevent arbitrary opening of the door 20 reliably.

Further, in the method for controlling the cooking apparatus of this embodiment, unless the door 20 is opened within a period ordinarily required to open the door 20, the locking mechanism 100 may resume the locking of the door 20, such that the cooking apparatus is less affected by an adverse effect caused by a manipulation error resulting from a changed mind or a mistake of the user, and prevent the arbitrary opening of the door 20 reliably.

### [Another Example of Control of Operation of Locking Mechanism]

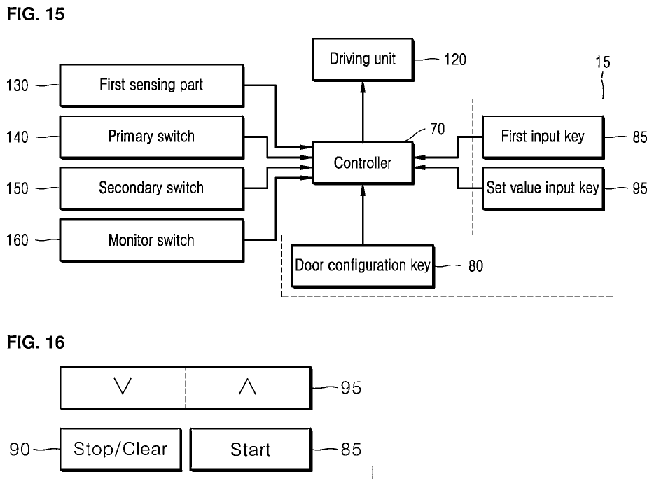

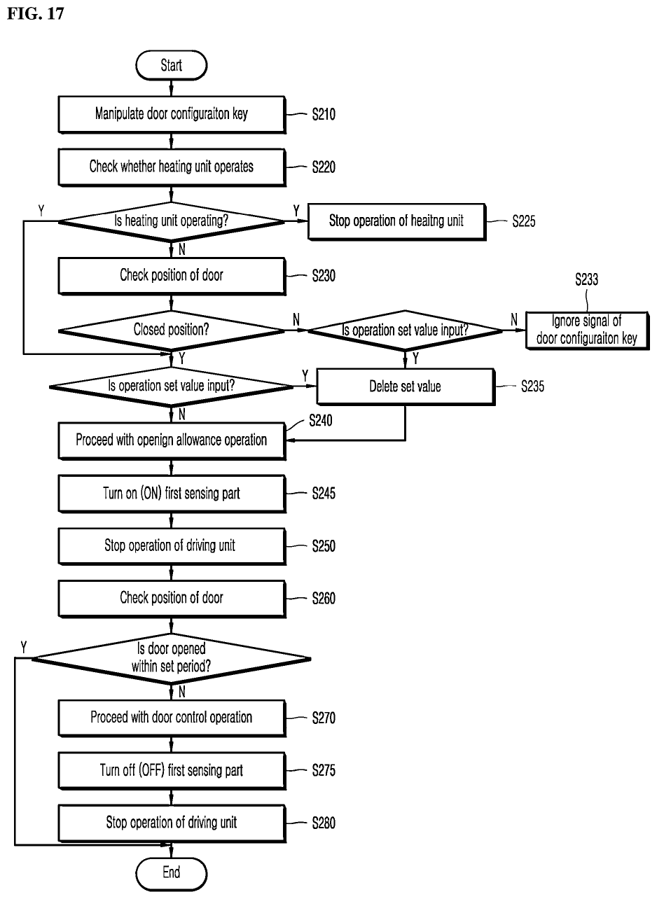

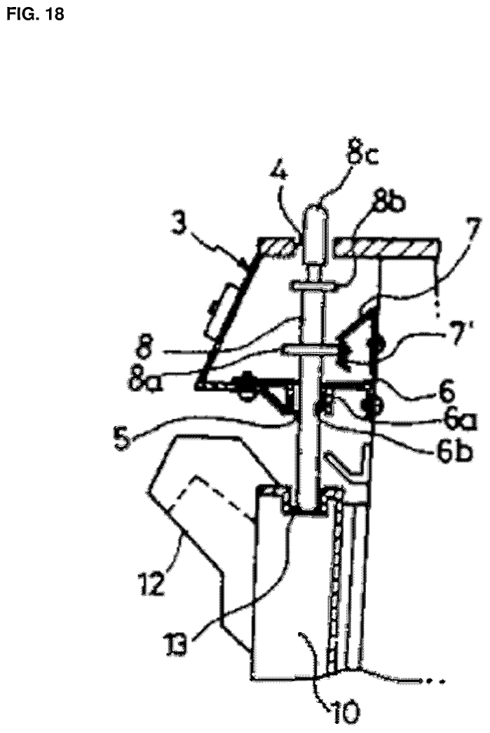

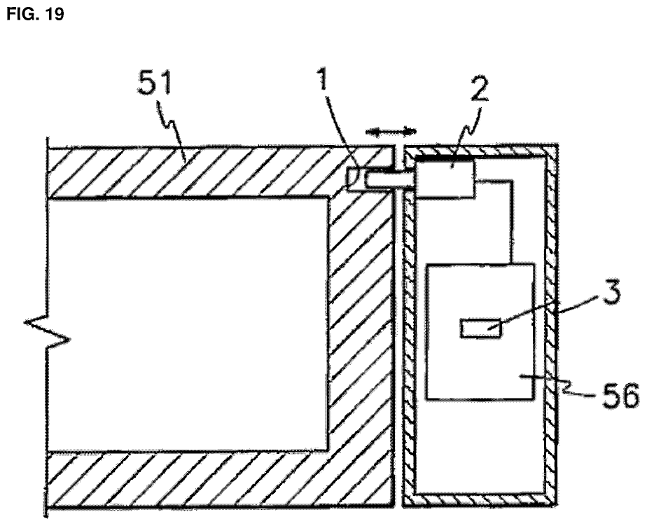

FIG. 15 is a block diagram schematically showing the configuration of a cooking apparatus of another embodiment, FIG. 16 is a view schematically showing switches illustrated in FIG. 15, and FIG. 17 is a flowchart showing a process in which the operation of the locking mechanism of one embodiment is controlled.

Hereinafter, the process of controlling the operation of the locking mechanism of another embodiment is described with reference to FIGS. 11 to 12, and 15 to 17.

Referring to FIGS. 15 and 16, in the cooking apparatus of another embodiment, the door configuration key and the second input key may be provided in such a way that the door configuration key and the second input key are combined into one input key.

That is, unlike the above-described cooking apparatus, the cooking apparatus of this embodiment may be provided in such a way that any one of the door configuration key 80 (see FIG. 13) and the second input key 90 (see FIG. 13) is removed from the input part of the control panel 15.

In this embodiment, the door configuration key 80 is not separately provided at the control panel 15, but is provided in such a way that the function of the door configuration key is added to the input key having the function of the second input key, for example.

That is, in this embodiment, the door configuration key 80 may be provided in such a way that the function of the door configuration key is added to any one of the input keys ordinarily provided to an ordinary cooking apparatus without the locking mechanism 100.

In an example, the door configuration key 80 may be provided in such a way that the function of the door configuration key is added to an input key function as the second input key in the above-described cooking apparatus. Accordingly, the door configuration key 80 may selectively provide the function of the second input key and the function of the door configuration key depending on whether the cooking compartment 14 (FIG. 2) is opened or the heating unit operates.

In the case where the function of the second input key and the function of the door configuration key are provided by one common input key as described above, the operation of the locking mechanism may be controlled as follows.

Referring to FIGS. 11 to 12 and FIGS. 15 to 17, the door configuration key 80 needs to be manipulated first for the user to open the door 20, as described with reference to the previous embodiment. As the user presses the door configuration key 80 (S210), the controller 70 may first check whether the heating unit operates (S220).

The door configuration key 80 is manipulated at a time of operation of the heating unit, the opening allowance operation does not proceed. That is, in the case where the door 20 is in the closed position at a time of operation of the heating unit, the opening allowance operation does not proceed even if the door configuration key 80 is manipulated.

As the door configuration key 80 is manipulated at a time of operation of the heating unit, the controller 70 may stop the operation of the heating unit instead of proceeding with the opening allowance operation. That is, as the door configuration key 80 is manipulated at a time of operation of the heating unit, the door configuration key 80, at this time, may perform the function of the second input key.

As the door configuration key 80 is manipulated in the state where the heating unit does not operate, the controller 70 may check the position of the door 20 (S230), and then determine whether to proceed with the opening allowance operation.

As descried with reference to the above-described embodiment, the second sensing part 140, 150, 160, specifically, the secondary switch 150 may check the position of the door 20.

In the case where the secondary switch 150 is turned off OFF, the controller 70 may check whether an operation set value is input. For example, the controller 70 may check whether a set value and the like in relation to the operation of the heating unit is input based on the manipulation of the set value input key 95.

In the case where the operation set value is not input in the state where the secondary switch 150 is off OFF, the controller 70 may ignore a signal that is input to the controller 70 based on the manipulation of the door configuration key 80. At this time, any operation in relation to the manipulation of the door configuration key 80 does not proceed (S233).

In the case where the operation set value is input in the state where the secondary switch 150 is off OFF, that is, in the case where the door configuration key 80 is manipulated in the state where the operation set value is input based on the manipulation of the set value input key 95 and the door 20 opens the cooking compartment 14, the controller 70 may proceed with a set value delete operation (S235).

In this embodiment, the set value delete operation is defined an operation of deleting an operation set value input by the input key. For example, the set value delete operation may be an operation of deleting a set value and the like that is input based on the manipulation of the set value input key 95 in relation to the operation of the heating unit.

That is, in the case where the operation set value is input in the state where the secondary switch 150 is off OFF as described above, the opening allowance operation does not proceed, and the operation of deleting the set value input based on the manipulation of the set value input key 95 may only proceed.

In summary, in the state where the door 20 is in the open position and the operation set value is not input, any operation does not proceed despite the manipulation of the door configuration key 80. Additionally, in the state where the door 20 is in the open position and the operation set value is input by the set value input key 95, the set value delete operation may only proceed out of the opening allowance operation and the set value delete operation, as the door configuration key 80 is manipulated.

Further, in the case where the secondary switch 150 is on ON, the controller 70 may be aware that the door 20 is in the closed position. At this time, the controller 70 may proceed with the opening allowance operation (S240).

In the case where the operation set value in input in the state where the secondary switch 150 is on ON, that is, in the case where the door configuration key 80 is manipulated in the state where the operation set value is input based on the manipulation of the set value input key 95 and the door 20 closes the cooking compartment 14, the controller 70 may allow the set value delete operation (S235) and the opening allowance operation (S240) to proceed together.

At this time, the locker 100 may move to the allowed position at the same time as the set value and the like input based on the manipulation of the set value input key 95 in relation to the operation of the heating unit.

In the case where the locker 110 is moved to the allowed position, and based on the movement of the locker 110, the first sensing part 130 is turned on ON (S245), the controller 120 may stop the operation of the driving unit 120, such that the locker 110 is prevented from making an additional movement unnecessarily (S250).

After the opening allowance operation proceeds, the position of the door 20 may be checked again (S260), and accordingly, the controller 70 may check that the position of the door 20 changes from the closed position to the open position after the opening allowance operation proceeds.

In the case where a change in the position of the door 20 to the open position is checked as a result of the check of the position of the door 20, the control of the locking mechanism 100's operation of opening the door 20 may end.

If the position of the door 20 does not change to the open position within the set period after the opening allowance operation proceeds, the controller 70 may proceed with the door control operation (S270).

As a result, the locker 110 is moved to the restricted position, and the first sensing part 130 goes into the off OFF state (S275), the controller 70 may stop the operation of the driving unit 120, such that the locker 110 does not make an additional movement unnecessarily (S80).

In the method for controlling the cooking apparatus of this embodiment, an additional input key for controlling a door locking function is not required in addition to an input key provided at an ordinary cooking apparatus, such that the door locking function is effectively controlled only with an existing input key.

Thus, unlike an existing cooking apparatus, the cooking apparatus of the present disclosure may ensure a decrease in the number of components and provide a reliable locking function, and may be highly compatible with the existing cooking apparatus.

Further, in the method for controlling the cooking apparatus of this embodiment, an additional input key for controlling a door locking function is not required, such that the possibility of a change in the design of the exterior of an existing cooking apparatus, caused by an addition of the input key, is suppressed.

The embodiments are described above with reference to a number of illustrative embodiments thereof. However, the embodiments are provided as examples, and numerous other modifications and equivalent embodiments can be drawn by one having ordinary skill in the art from the embodiments. Thus, the technical scope of protection of the subject matter of the disclosure is to be defined according to the following claims.

### DESCRIPTION OF REFERENCE NUMERALS

10: Main body
11: Cavity
12: Front plate
13: Cabinet
14: Cooking compartment
15: Control panel
16: Input part
17: Display unit
20: Door
20a: Door main body part
20b: Handle part
21: Door panel
25: Door frame
26: Lateral surface
27: Penetration hole
40: Latching mechanism
41: Latch lever
43: Latch
50: Latch board
51: Main body part
52: Fastening boss
53: Latch fixation part
53a: Insertion hole
53b: Hold step
54: First support part
54a: First support boss
54b: Second support boss
55: Second support part
55a: Support frame
55b: Support shaft
56: Third support part
56a: Hook
57: Fourth support part
70: Controller
80, 80: Door configuration key
85: First input key
90: Second input key
95: Set value input key
100: Locking mechanism
110: Locker
111: Rotation shaft
113: Lever
113a: First lever part
113b: Second lever part
115: Contact projection
120: Driving unit
130: First sensing part
140, 150, 160: Second sensing part

1. A cooking apparatus, comprising:
a main body configured to have a coking compartment therein and an open front surface;
a door disposed at a front of the main body and configured to open and close the cooking compartment;
a latching mechanism installed at the door in such a way that the latching mechanism is selectively coupled to the main body, and coupled to the main body to fix the door in a closed position; and
a locking mechanism configured to selectively restrict a movement of the latching mechanism,
the locking mechanism, comprising;
a locker configured to comprise a lever provided in such a way that the lever is movable to a restricted position where the lever restricts the movement of the latching mechanism and movable to an allowed position where the lever allows the movement of the latching mechanism;
a driving unit configured to move the lever; and
a door configuration key configured to generate a signal for operating the driving unit.

2. The cooking apparatus of claim 1, the locker, comprising:
a rotation shaft rotated around an up-down axis by the driving unit; and
the lever configured to protrude from the rotation shaft in a centrifugal direction, and to move in connection with a rotation of the rotation shaft.

3. The cooking apparatus of claim 2, wherein the latching mechanism moves upward in a fixed position to move from the fixed position to a unfixed position,
and in the restricted position, the lever restricts an upward movement of the latching mechanism, over the latching mechanism.

4. The cooking apparatus of claim 2, wherein the cooking apparatus further comprises a first sensing part configured to detect a position of the lever,
the locker further comprises a contact projection configured to protrude from the rotation shaft in the centrifugal direction,
the contact projection moves in connection with the rotation of the rotation shaft,
the first sensing part detects a position of the lever while being turned on ON/off OFF by the contact projection, and
as the first sensing part is turned on ON, a movement of the locker stops.

5. The cooking apparatus of claim 1, wherein the cooking apparatus further comprises a first manipulation switch configured to generate a signal different from a signal of the door configuration key,
as the first manipulation switch and the door configuration key switch generate a signal at the same time, an operation of the driving unit stops such that the lever remains in the allowed position.

6. A method for controlling a cooking apparatus comprising a latching mechanism configured to fix a door, which opens and closes a cooking compartment while moving to a closed position and an open position, in the closed position, and a locker provided in such a way that the locker is movable to a restricted position where the locker restricts a movement of the latching mechanism or movable to an allowed position where the locker allows a movement of the latching mechanism,
wherein an opening allowance operation proceeds only when the door is in the closed position, at a time of manipulation of a door configuration key, and
the opening allowance operation is an operation of moving the locker to the allowed position.

7. The method of claim 6, wherein the cooking apparatus further comprises an input key for inputting an operation set value,
at a time of manipulation of the door configuration key, a set value delete operation proceeds in a state where the operation set value is input by the input key, and
the set value delete operation is an operation of deleting the operation set value input by the input key.

8. The method of claim 7, wherein in a case where the door is in the open position, and the door configuration key is manipulated in a state where the operation configuration value is input by the input key, the set value delete operation only proceeds out of the opening allowance operation and the set value delete operation.

9. The method of claim 7, in a case where the door is in the closed position, and the door configuration key is manipulated in a state where the operation configuration value is input by the input key, the opening allowance operation and the set value delete operation proceed together.

10. The method of claim 6, wherein the cooking apparatus further comprises a second sensing part configured to detect whether the door is in a closed position, in a case where the door moves from the allowed position to the closed position and the second sensing part is turned on ON, a door control operation proceeds, and
the door control operation is an operation of moving the locker to the restricted position.

11. The method of claim 6, wherein the cooking apparatus further comprises a heating unit configured to generate heat of a high frequency into the cooking compartment, and
at a time of operation of the heating unit, the opening allowance operation does not proceed eve if the door configuration key is manipulated in a state where the door is in the closed position.

12. The method of claim 6, wherein as the door configuration key is manipulated while the heating unit operates, an operation of the heating unit stops.

13. The method of claim 6, wherein the cooking apparatus further comprises an input key for inputting an operation set value, a setting cancelation key deleting an operation set value input by the input key, and a heating unit generating heat or a high frequency into the cooking compartment, and
as the door configuration key is manipulated at a time of operation of the heating unit, the opening allowance operation proceeds.

14. The method of claim 6, wherein unless a position of the door changes to the open position within a set period after the opening allowance operation proceeds, a door control operation proceeds, and
the door control operation is an operation of moving the locker to the restricted position.

15. The method of claim 6, wherein the cooking apparatus further comprises a first sensing part configured to detect a position of the locker,
as the locker moves to the allowed position and contacts the first sensing part at a time when the opening allowance operation proceeds, the first sensing part is turned on ON, and
as the first sensing part is turned on ON, a movement of the locker stops.
